(19) United States
(12) Patent Application Publication
(10) Pub. No.: US 2013/0246303 A1
(43) Pub. Date: Sep. 19, 2013

(54) CORPORATE ACTIONS AUTOMATION SYSTEM AND METHOD

(71) Applicants: Michael F. FINCK, New York, NY (US); Michael P. SILVERENCE, Staten Island, NY (US)

(72) Inventors: Michael F. FINCK, New York, NY (US); Michael P. SILVERENCE, Staten Island, NY (US)

(73) Assignee: THE BANK OF NEW YORK MELLON, A NEW YORK BANKING CORPORATION, New York, NY (US)

(21) Appl. No.: 13/420,227

(22) Filed: Mar. 14, 2012

(51) Int. Cl. G06Q 40/06

(52) U.S. Cl. 705/36 R

(57) ABSTRACT

A data processing system processes information associated with an underlying corporate action (CA) and includes a communications module; a message processing module that receives corporate action data; an assignment module that parses the data; an external data feed module queries and receives third party information related to the notice and identifies discrepancies between data elements and the third party information and requests confirmation and/or correction of the information responsive to an identification of discrepancies; an announcement processing module which, responsive to approval of a golden event, generates an announcement concerning the underlying corporate action to one or more of the issuer, a securities exchange, and a securities clearinghouse over the communications network, and responsive to the publication of the announcement, the external data feed module again queries and receives third party information related to the announcement and reverifies consistency of the third party information with the announcement.

### BACKGROUND

This application is directed to a computer-implemented system and method useful for electronically processing and automating current manual operations relating to storing, calculating, and distributing data/information required in connection with a corporate action (CA), in particular, a corporate action that involves use of a Depositary Receipt (DR), even more particularly, to corporate actions involving DRs for which Depositary Service Fees (DSF) are charged and/or cash distribution/dividends (cash D/D) are paid.

A corporate action is an event initiated by a public company that affects the securities (equity or debt) issued by the company. Some corporate actions such as a dividend (for equity securities) or coupon payment (for debt securities, i.e. bonds) may have a direct financial impact on the shareholders or bondholders. Another example is a call (early redemption) of a debt security. Other corporate actions such as stock split may have an indirect impact, as the increased liquidity of shares may cause the price of the stock to rise. Some corporate actions, such as a name change, have no direct financial impact on the shareholders. Corporate actions are typically agreed upon by a company's board of directors and authorized by the shareholders.

When a company announces a corporate action, registered shareholders are told of the event by the company's registrar. Financial data vendors (“third party vendors”) collect such information and disseminate it either via their own services to institutional investors, financial data processors, or via online portals in the case of individual investors.

When a publicly-traded company issues a corporate action, it is initiating a process that will bring actual change to its stock. By understanding these different types of processes and their effects, an investor can have a clearer picture of what a corporate action indicates about a company's financial affairs and how that action will influence the company's share price and performance. This knowledge, in turn, will aid the investor in determining whether to buy or sell the stock in question. The current CA process is technically difficult and prone to errors due to the large number and types of CA's that are processed yearly, as discussed below.

Various reasons for companies to use corporate actions include return of profits to shareholders (e.g., cash dividends); influencing the share price (e.g., stock splits, reverse splits, and buybacks); or corporate restructuring (e.g., mergers and spinoffs). Approximately 200,000 corporate actions such as dividends, bond redemptions, rights offerings and mergers are announced each year by publicly traded companies and other issuers or offerors in the U.S. alone. Most of these announcements still require many tedious manual steps, making the process error-prone, time-consuming and costly. Over the years, these issues have had a negative impact on investors across the financial community.

Processing of corporate actions is complex, since there are over 60 corporate action event types, and an event may dictate a mandatory action or offer voluntary participation, with multiple options. The corporate action itself is not simple either, as there may be different counterparties that communicate with each other in different parts of the process, which generates a complex web of communication. The use of proprietary formats and the currently required manual work makes “matching” of information complex and difficult, and error prone. The entire event process can take months, and processors must deal with position changes, settlement and distribution and sometimes questionable data quality. Manual processing of corporate actions places a heavy drain on expensive resources. Further, errors made during the corporate actions process can result in significant financial losses to the parties due to potential litigation risks and compensation risks, as well as client reputational risk, including the loss of clients. As a result, maintenance of significant reserves (e.g., 7-10%) of the transaction are often felt to be necessary to mitigate the financial risk of the depositary agent.

In recent years, there has been increasing focus on automating the processing of corporate actions because of the risk associated with the high level of manual processing that typically has been necessary. To help mitigate the risks and drive down the costs associated with processing corporate actions, DTCC, SWIFT and XBRL US have joined forces to implement an initiative that builds on the work undertaken globally to promote existing ISO (International Organization for Standardization) standards for corporate actions, and which integrates the benefits of XBRL (eXtensible Business Reporting Language) electronic data tagging technology. The collaboration promotes straight-through-processing (STP) by electronically capturing data directly from issuers at the point that a corporate action is announced, and in a standardized format. XBRL is a global technology standard based on XML that makes business information computer-readable and more easily consumed and processed. The XBRL taxonomy for corporate actions reporting is based on elements of the ISO 20022 corporate actions global standard, and is vastly more streamlined than current reporting and announcement processes.

In order to help the European market infrastructures become Giovannini compliant in 2011 and at the request of other market players, SWIFT Standards has reverse engineered the ISO 15022 Corporate Action messages into ISO 20022. Such corporate action messages, in whatever format, are designed to reduce the risks involved by providing for the unambiguous reporting of the nature of the event, options available to the shareholder and response deadlines, the specific impact on a safekeeping account.

Many corporate actions involve DR's. For example, given our global economy, mergers and acquisitions outside the U.S. increasingly require the cross-border transfer of funds. Depositary receipts are well-suited to facilitate these transfers. One of the most common types of DRs is the American depositary receipt (ADR), which are negotiable U.S. securities that generally represent a non-U.S. company's publicly traded equity. Depositary Shares (DSs) represent an equity share of a foreign-based company available for purchase on a stock exchange. American Depositary Shares (ADSs) are issued by depositary banks in the U.S. under agreement with the issuing foreign company; the entire issuance is called an American Depositary Receipt (ADR), and the individual shares are referred to as ADSs.

DRs have spread to other parts of the globe in the form of global depositary receipts (GDRs) (the other most common type of DR), European DRs and international DRs. ADRs are typically traded on a U.S. national stock exchange, such as the New York Stock Exchange (NYSE), while GDRs are commonly listed on European stock exchanges such as the London Stock Exchange (LSE). Both ADRs and GDRs are usually denominated in U.S. dollars, but can also be denominated in Euros.

A Depositary Receipt is issued by a U.S. depositary bank, such as BNY Mellon, for example, when the underlying shares are deposited in a local custodian bank, usually by a broker who has purchased the shares in the open market. Once issued, these certificates may be freely traded in the U.S. over-the-counter market or, upon compliance with U.S. SEC regulations, on a national stock exchange. When the DR holder sells, the DR can either be sold to another U.S. investor or it can be canceled and the underlying shares can be sold to a non-U.S. investor. In the latter case, the DR certificate would be surrendered, and the shares held with the local custodian bank would be released back into the home market and sold to a broker there. Additionally, the DR holder would be able to request delivery of the actual shares at any time. The DR certificate states the responsibilities of the depositary bank with respect to actions such as payment of dividends, voting at shareholder meetings, and handling of rights offerings. In addition, under SEC Section 17 Regulations, the U.S. Depositary Bank is considered the de facto “issuer”, thus imposing certain Corporate Action reporting requirements and standards.

Corporate messages about DRs, such as dividend announcements, are sent from depositary banks to stock exchanges, investors and other intermediaries. These messages are often communicated as text, which requires re-keying of the data by the various recipients, lengthening the process and raising the chance of inaccuracy.

More recently, automated data processing systems have been used to process limited aspects of DR's associated with Corporate Actions in an attempt to reduce the burden on the administrative agent due to the extensive analysis required of multi country event notifications (i.e., over 72 possible countries) and possible number of different corporate actions (i.e., as mentioned above, over 60 different types of DR's), for over 1700 issuers, i.e., non-U.S. companies, that can be encountered. Efforts to date have included automated inputting of information received electronically from, for example, SWIFT messages where an application reads/parses the incoming message, assigns the incoming message to an Issuer, determines a CA Event type, and other pertinent data, and assigns a DR group to the underlying CA event. More recent initiatives include, as discussed above, a move to a standard message format, e.g., XBRL that supports financial reporting within the U.S. government, e.g., the Securities Exchange Commission (SEC).

However, many CA's involve Depositary Service Fees (DSF) and/or the payment of cash dividends. Current automated systems used for front-end processing of CA's do not address automated payment calculation, delivery, and accounting for DSF's or dividends.

What is needed is an improved system and method that provides technology that allows delivery of Corporate Actions announcements in an automated and standardized format for provision to and retrieval by interested and required parties. What is further needed is a system and method to improve data quality and reduce processing cost and time of corporate actions. What is also needed is a system and method for publication of corporate actions announcements regarding Depositary Receipts (DRs) in a standardized format for downstream processing by stock exchanges, brokerage firms and investors. What is even further needed is a system and method that enables straight-through-processing of corporate actions announcements to improve timeliness, reduce costs, and streamline processing for DR investors. What is also needed is a system and method that handles DSF and distributions, including cash dividends and stock rights payment calculations and delivery, and accounting for corporate actions associated with DR's.

### SUMMARY

Through various embodiments described herein, the system and method of this disclosure reduces the risk and complexity associated with the processing, evaluation, modification, and certification of corporate actions, particularly corporate actions associated with depositary receipts, i.e., ADRs.

In an embodiment, a data processing system including a processor for analyzing, processing, and outputting information associated with an underlying corporate action (CA), wherein the system includes a communications module configured to operably couple to an external communications network; a message processing module operable to receive, via the communications module, data from an issuer providing notice of the underlying corporate action; an assignment module configured to parse the data from the issuer and to associate one or more of an issuer, a corporate action event type, and a responsible group to the underlying corporate action and to store associated data elements in a memory; an external data feed module communicably coupled to the communications module and configured to query and receive third party information related to the notice of the underlying corporate action, said external data feed module operable to identify discrepancies between data elements in the memory and the third party information and to request confirmation and/or correction of the received third party information responsive to an identification of one or more discrepancies between the data elements in the memory and the third party information; an administrative module coupled to the external data feed module and through which, responsive to resolution of all discrepancies between the data elements in the memory and the third party information, a relationship manager approves the underlying corporate action as a golden event, any corrected data elements being stored in the memory; an announcement processing module which, responsive to approval of the golden event, prepares and publishes an automated announcement concerning the underlying corporate action to one or more of the issuer, a securities exchange, and a securities clearinghouse over the external communications network, wherein, responsive to the publication of the announcement, the external data feed module again queries and receives third party information related to the announcement and reverifies consistency of the third party information with the announcement; the external data feed module requesting confirmation and/or correction of the received third party information related to the announcement responsive to an identification of one or more discrepancies between information associated with the underlying corporate action stored in the memory and the third party information.

In another embodiment, a computer-implemented method for analyzing, processing, and outputting information associated with an underlying corporate action (CA), wherein the method includes providing a data processing system comprising a memory coupled to a processor and containing a database therein configured to at least store information related to the underlying corporate action and client-related information, said data processing system being communicatively couple to a communications network; analyzing, by the processor, a CA notice received from an issuer; requesting, by the processor, alternative notification information for the CA notice from a third party data vendor; confirming, by the processor, consistency between CA information in the CA notice and the alternative notification information; responsive to any data inconsistency, requesting correction of either the CA information, the alternative notification information, or both; responsive to data consistency, declaring a golden event and publishing a CA announcement; reviewing alternative data sources provided in response to the CA announcement and determining whether any new data inconsistency exists; and prior to any further processing, ensuring that said any new data inconsistency has been resolved, wherein said any new data inconsistency is identified by the processor.

In another embodiment, an article of manufacture includes a non-transitory computer-readable storage medium that contains computer-executable code therein which, when executed by a processor, causes the processor to carry out functions that analyze, process, and output information associated with an underlying corporate action (CA), wherein the executable code is operable to analyze, by the processor, a CA notice received from an issuer; request, by the processor, alternative notification information for the CA notice from a third party data vendor; confirm, by the processor, consistency between CA information in the CA notice and the alternative notification information; responsive to any data inconsistency, request correction of either the CA information, the alternative notification information, or both; responsive to data consistency, declare a golden event and publish a CA announcement; review alternative data sources provided in response to the CA announcement and determine whether any new data inconsistency exists; and prior to any further processing, ensure that said any new data inconsistency has been resolved, wherein said any new data inconsistency is identified by the processor.

The system and method of this disclosure provides various capabilities as discussed more fully in the detailed description below.

### BRIEF DISCUSSION OF THE DRAWINGS

FIG. 1 provides a functional block diagram of an embodiment of a computer-implemented and networked system for electronically generating and processing corporate actions;

FIG. 2 provides an exemplary flow chart of a process for electronically generating and processing corporate actions of an embodiment; and

FIGS. 3A-3E provide additional aspects of a process for electronically generating and processing corporate actions in accordance with an embodiment of this disclosure.

### DETAILED DESCRIPTION

In the discussion of various embodiments and aspects of the system and method of this disclosure, examples of a processor may include any one or more of, for instance, a personal computer, portable computer, personal digital assistant (PDA), workstation, or other processor-driven device, and examples of network may include, for example, a private network, the Internet, or other known network types, including both wired and wireless networks.

Those with skill in the art will appreciate that the inventive concept described herein may work with various system configurations. In addition, various embodiments of this disclosure may be made in hardware, firmware, software, or any suitable combination thereof. Aspects of this disclosure may also be implemented as instructions stored on a non-transitory machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions.

In addition, the system and method of this disclosure are discussed in embodiments herein as being carried out by various “modules” having identified functional attributes. As would be appreciated by a person with skill in the art, these various modules may be implemented by one or more specially programmed processors that carry out various functions defined by, for example, the flow charts/algorithms described herein, as well as the functional objectives/requirements defined by the various tables in the Appendix to this disclosure.

In one or more embodiments, the Corporate Actions (“CA”) application platform of this disclosure collects corporate action notifications from various sources related to the underlying security which can be filed in a group electronically and used to create a DR corporate action. The term “application platform” is intended to include a networked data processing system with attendant processor(s), memory with structured database, network connections, and input/output devices such as displays, printers, keyboards, etc. The term “CA application” or “platform”, includes software functionality working under the control of a computer processor to carry out various functions described herein.

Conventionally, business applications have been developed using desktop application software such as a PowerBuilder application, an integrated development environment owned by Sybase, a division of SAP. However, web-based development tools have been developed that allow developer flexibility and improved development timelines, and which do not limit developers to desktop software installations. Such alternative development tools for programming the CA application platform may also be provided by Java development tools that may include the use of Java-based tools such as Java Server Pages (JSP) technology and Visual Studio, for example, or other software tools.

In addition, to ensure adequate data security in the CA application platform, access control and user identification and verification may be utilized. In an embodiment, an IBM software product, Resource Access Control Facility (RACF), may be used to provide access control and auditing functionality that provides features including identification and verification of a user via user id and password check (authentication), protection of resources by maintenance of access rights (authorization), and logging of accesses to protected resources (auditing). RACF establishes security policies rather than just permission records and can set permissions for file patterns that may be used for a file (or other object) created at a later time.

In an embodiment, a DR Event may be created with DR-specific memory fields as they relate to corporate actions. In addition, the CA application platform may be configured to eliminate duplicate data entry by using links between the CA application platform and other processing applications. In one embodiment, the CA application platform is an internet application that ensures that worldwide staff have direct access realtime to DR corporate actions. Use of online processing also minimizes financial, legal and reputational, risk by allowing greater transparency in the processing of DR corporate actions. In one or more embodiments, information related to the DR(s) or the CUSIP(s) for the DR corporate action can be displayed on a DR Event screen to streamline the processing of transactions since processing personnel will no longer have to source DR or CUSIP-specific data from other applications.

In one or more embodiments, and by including the DR-specific corporate action information in the CA Application, all of the corporate action information will be stored electronically in a central location available to all DR staff worldwide in their time zone thus making replying to client inquiries related to corporate actions easier and more timely.

In one or more embodiments, a “MasterFile” may be stored in memory, e.g., in a database, in order to facilitate functions that have been requested related to a DR Event in the CA application. Data elements stored in the MasterFile may include, in one or more embodiments, for example:

(1) Termination Period: entered in number of days, not months or years, by definition begins the day after the Termination Date and ends the day before the Initial Sale Date;

(2) Initial Sale Date: Termination Date+Termination Period+1 calendar day as the default value, should not be a weekend day or holiday and can be manually adjusted after the default value;

(3) CCC code: needed for Edgar filings, and used in combination with the CIK to submit a filing via EDGAR. The CCC is eight characters having at least one number (0-9) and at least one special character (@, #, $, *). The CCC is also case-sensitive and must be entered exactly as created, in lower case.

(4) CIK code: Central Index Key code needed for EDGAR/SEC filings, the CIK is a unique, public number that is assigned to each entity that submits filings to the SEC. Use of the CIK allows the SEC to differentiate between filing entities with similar names;

(5) Voting: Voting per Deposit Agreement: values—must select one: Auto Proxy, Discretionary, Non-Discretionary;

(6) Blocking: Blocking values—must select one: Custodian, DTC, DTC with disclosure, None (Default=None, but can be changed);

(7) DTC Eligible: Yes or No values

(8) DTC Participating: Indicates whether the security is participating for clearance/settlement through DTC.

In one or more embodiments, a DR Event may be created which contains information germane to the particular DR corporate action. The idea is to centrally locate both the underlying security and DR portions of the corporate action linking them together to take advantage of information contained within the Underlying Security Event, for example, local record dates and distribution rates on SWIFT messages from a local custodian that are needed to finalize the DR Event.

One or more embodiments of this disclosure enhance the workflow from the creation of the DR Event, either from an existing Underlying Event or as a standalone DR Event, up to the final DR corporate action announcements to the street (i.e., required and interested parties), determination of DSF's and/or cash dividends, and electronic notification of the same to necessary parties. For example, various aspects of this disclosure enable streamlining and minimizing the steps that that must be utilized to finalize a corporate action. Currently, for example, dividend data must be entered with respect to an underlying event, and then reentered in a file for the DR corporate action.

A Depositary Service Fee (DSF) is a fee charged to selected DR holders. Not all DR programs will have a DSF assessed. For example, if the DSF is not stated in the Deposit Agreement or if the Relationship Manager (RM) and/or Regional Head (RH) have decided not to charge the DSF, then the fee will not be coded for charging in the system. DSF information may be stored centrally in a memory, instead of needing to refer to the deposit agreements every time the DSF information is needed. Three fields may be included in MasterFile, including: 1) DSF in Deposit Agreement (Y/N); 2) Charge DSF (Y/N) and 3) Net DSF from Cash distribution (Y/N). Additional field(s) may be added to MasterFile.

Another aspect of DSF processing is providing a report for the DR Division consolidating information from the MasterFile to more accurately determine if/when a DSF can be charged and to assess potential revenue. DR operators may provide the latest DSF and Dividend data to MasterFile for each Depositary Receipts (DR) CUSIPs. These fields and the current DSF fields may be used in a DSF Forecast report that may be used to determine how many DRs can be charged a DSF, how many were charged a DSF, and what the rate of the DSF is to be. The Data in this report may be used to perform accrual accounting of the DSF and determination of the DSF Event. The accrual accounting entries may be manually entered into the Dividend application; this includes any/all monthly adjustment of the Accruals. Since the monthly adjustment process is generally manually intensive, not all DR Issues/CUSIPs participate in the Accrual accounting process. To reduce processing and reporting requirements, participation may be limited to issues with anticipated revenue of over $500,000.00, for example. Also, the DSF Event announcements may be electronically compiled, generated and sent to the Security Depositories and Registered Shareholders (RS).

In addition, this functionality may be configured to address any and all reports and output that may be needed to accommodate the Dividend DSF Web application and all enhancements to the systemic feeds (internal and external) into or out-of the Dividend DSF workspace.

Various flags, fields, events, relationships, and associated data must be handled by the CA platform, and/or stored in a database/memory. The Appendix to this disclosure provides a tabular listing of various exemplary actions, objectives, and system capabilities for data processing by the CA platform, identified as numbered “requirements” or “objectives” associated with various functional aspects of the data processing system and method of this disclosure. The use of a data bit or bits in a digital word stored in a memory as a “flag” is known in the art.

Assessment of a DSF may be determined by running a report and having the Relationship Managers validate/verify that the DSF will be assessed. This may be done 45 days prior to the proposed date to declare as the record date for the DSF, as notice must be given to the Security Depositories (e.g., DTC, ClearStream and EuroClear) and may be made available on the DR Website 30 days prior to the record date of the assessment. The Relationship Managers (RM) review the report, and approve proceeding with the DSF process for each of their Clients. Requests from an RM to not assess a DSF may be approved by a DR Regional Head (RH) or designee. Other approval procedures and mechanisms may be implemented. Once approval is received, a DSF announcement may be sent to the affected Security Depositories. In the interim, a Record Date Registered shareholder (RS) list may be established to assess and send collection notifications to the RS population. In addition, a position listing is requested from Security Depositories, so that reconciliation of outstanding positions can be performed as of the record date. DSF particulars (e.g., Record Date, Collection Date and Rate) may be input into the database, e.g., in the MasterFile. An estimation of anticipated receipts may also be made. When payments are received, e.g., by Fed-wire, ACH, or Check), they may be recorded in the database, and general ledger (GL) tickets may be generated for further processing.

DSF Accruals may also be forecast to provide an estimate of expected income from the assessment of a DSF. This is normally done 60 days prior to year-end, as each RM needs to be contacted and respond to the question of; which of their Client's CUSIPs/Issues they foresee assessing a DSF Fee for in the upcoming year. Requests from the RM's to not assess a DSF may be confirmed/approved by a DR Regional Head (RH). Once the DSF processor has a list of all clients that should have a DSF assessed for the upcoming year, the Accrual process may be commenced by running “dummy” record date position reports, and calculating which Clients CUSIPS/Issues currently have an anticipated DSF of $500,000.00 or more, or any other agreed value, for example. Financial General Ledger (GL) tickets may be written out and processed by the CA platform and stored in a memory. Each subsequent month the DSF processor may run monthly record dates position reports and verify the last month's share positions to determine if the outstanding DR positions have changed enough to warrant changes to the Accruals (positive or negative), within some agreed-upon threshold, e.g., +/−$10,000.00. If any of the positions warrant a change to the Accruals, new entries may be used, and previous entries may be backed out. Necessary adjustments to the database may be made by making the necessary correcting (GL) entries. Note: Corporate Actions such as forward/reverse splits, ratio changes, CUSIP changes, etc. will affect the share positions, and subsequently the accruals.

In order to properly track and account for the DSF of each the Accrued CUSIPs, the DSF Processor should link the DSF Accruals and Actual DSF Event transactions. The DSF Processor will back out the Accrual amounts from both DR-Ops and The Bank's Financial System and input the Actual amounts received. This is done even if the Accrual amounts and the Actual amounts are the same. In addition, if the amounts differ (positive or negative) a reversal of Income Memo is written and presented to management for signatures.

The DSF Processor may also perform a claims process by analyzing the anticipated funds and the funds received from each of the Security Depositories, and the registered shareholders that were notified and billed. If the funds are not received within 30 days of the collection date, a claim letter may be generated and sent to the delinquent party(s). Follow-up letters and possible legal notices may also be generated, if the funds are still not received within 30 days after the first claim letter.

In one or more embodiments, the DSF component functionality may include the following features:
Calculating & displaying information in the Corporate Action application to enhance the DSF process.
Update Corporate Action DSF fields/values and displayed information with the most current data in MasterFile, CA Dividend and DR-Ops;
Provide an accrual accounting process, both for new clients and existing clients;
Provide a Dividend Web Screen to Input/Update the DSF Fee information to be used for DSF Accruals, DSF Events and DSF Payments as well as Actual/Forecast screen for the RM and RH;
Support RM decision-making on assessing DSF for accrual Accounting;
Provide an approval process such that the RH can determine whether a DSF will be assessed for the Accrual Accounting process (Approve “all” functionality);
Provide structure to store the Accruals in Corporate Action application;
Provide rules table for Corporate Actions that will effect the Accruals;
Systematically calculate and adjust Accruals on a monthly basis;
Provide process to remind RM to make decision on assessing DSF (Event);
Provide approval process such that the RH can determine whether a DSF will be assessed (Event);
Create announcement letter for the DSF Event;
Provide functionality to e-mail announcement letter notifications to the Security Depositories;
Provide an e-mail DSF alert process to notify and bill the registered shareholders (E-mail of daily and/or monthly Event R/Ds).
Provide a process that allows for a DSF to be deducted from a Cash distribution;
Provide DSF Posting functionality to the web;
Provide DSF reports to accommodate the Financial, Reconciliation and Client reporting of the DSF;
Track and systemically adjust DSF Accruals and Events for Corporate Actions (Stock Splits, spin-offs, CUSIP changes) and Program life cycles.

At the time of a new Issuer/Program appointment, the DR Fee rule may be set-up in MasterFile. In addition to the MasterFile set-up, the relationship or designee (RM/D) will need to validate the DSF fee to be assessed and the DSF Service period (YYYYMM) to (YYYYMM) in the Corporate Action Dividend DSF applications. The CA Dividend DSF screen should include these MasterFile fields and CA Dividend values in order to help the RM/D determine the DSF fee to be assessed: (1) DSF in Deposit Agreement >0; (2) Charge DSF (Y/N); (3) Net DSF from Cash distribution (Y/N); (4) Program Effective Date; (5) DSF Service period (YYYYMM) to (YYYYMM) Prior, Current, Forecast, will allow updates; (6) Forecast DSF Record Date (YYYYMMDD) match to DSF service period; (7) Forecast DSF Fee Rate (value) Prior, Current, Forecast service period, also will allow updates; (8) Total Cash distribution Fee assessed (value) Prior, Current, Forecast service periods; (9) Total DSF Fee assessed (value) Prior, Current, Forecast service period; (10) Total Stock Dividend assessed (value) Prior, Current, Forecast service period; (11) Total Rights Fee Assessed (value) Prior, Current, Forecast service period; (12) Total available fee to be assessed (value) Prior, Current, Forecast service period; (13) Assess DSF with Cash Events (Y/N); (14) DSF (Event & Annual) (Value); (15) Cash distribution Fee (Event & Annual) (Value); (16) Multi-DSF Events (Y/N)—If yes, how many (Value); (17) Negotiated Fee holders (Y/N) If yes, number of shares (Value) DSF Rate to apply (value), (18) Accrual accounting required (Y/N) if yes, percentage, (19) Cash & DSF annual cap (Y/N), if yes, (value), (20) Either Cash distribution or DSF.

The RM/D will then forward the DSF information to the RH/D to approve the DSF Fee to be assessed and the DSF Service period in the CA Dividend application. Once the rules are set-up in MasterFile and the CA Dividend application, the system will track, calculate and display the information using the most current data available. The MasterFile rules and the CA Dividend DSF information will be the driver for the DSF Accrual and DSF Event processes. Each year the RM/D will be notified that a DSF re-certification is available and, if no action is taken, the CA system will use the pervious service periods information.

The Corporate Action Dividend application may perform a analysis on a designated day, e.g., the 3rd to last business day of the month, of the Issuer/Program MasterFile Fee rules, and the new fields/values from the Corporate Action Dividend application will determine if a DSF will be assessed, and a DSF Event is required. Once that determination is made, the CA Dividend application may do an analysis of the CA DR Events and will prompt the Dividend processor/approver whether the DSF should/could be processed either in conjunction with the Issuer/Programs Cash Event (Cash distribution, Cash Disbursement, Rights). If no Cash Event exists, the system will schedule the DSF Event as a standalone DSF Event according to the forecasted Record Date schedule. The CA Dividend application may be provided with the flexibility to stop/cancel a DSF within a 48 hour/two days of the record day and reinitiate a DSF Event at anytime, up to the last business day of the year.

There may be two processes used for the loading of DSF payments to the Corporate Action Dividend DSF application—the first will be an automated process in the cases when a DSF is processed in conjunction with a Cash Event. On the payable day of the Cash Event, the Corporate Action Dividend DSF application will match the DSF payment received from the Cash Event to the system generate DSF Event that was created on the Record date of the Cash Event. The second process will be when a DSF processor manually loads the DSF Event payments received from the Security Depositories and the Register Shareholders (e.g., via Fedwire, check, or ACH payment) into the Corporate Action Dividend DSF application. In both cases, the Corporate Action Dividend DSF application will update and track the actual payments received to the Funds anticipated and will update the financial reports with the payment information and produce the tickets which will be input to the financial system.

The Corporate Action Dividend application will perform a analysis on a desired day, e.g., the 3rd to last business day of the month, of the Issuer/Program MasterFile Fee rules and the new fields/values from the Corporate Action Dividend application to determine if a DSF will be assessed, if DSF accrual accounting is required, and if adjustments are required to the any of the accruals already established. Once that determination is made, the CA Dividend application may calculate, track, create reports and create financial ticket for the DSF accruals. The accruals will be for a particular DSF Service period and will closed out with the DSF Event being process for that service period. The only exception to this is if the DSF event happens to be processed within the service period; then the Accrual will run to the end of the service period. There could be times when DSF accrual accounting is being calculated for the same program but, for two different service periods.

There may be two processes for canceling a DSF Event in the Corporate Action Dividend application, the first will be an automated process in cases where a upcoming DR cash event is scheduled for the same program that a DSF Event has already been processed but, the record date of that DSF event is greater than some period of time, e.g., 72 hours/3 days away. In these cases, the CA Dividend application will need to produce a retraction DSF announcement canceling the scheduled DSF Event and also notify the Dividend Operation group that the DSF could/should be processed with Cash Event. The second process will be when a DSF processor manually cancels the DSF Event by entering a cancel request into the CA dividend application. In this scenario, the CA Dividend application will need to produce a retraction DSF announcement canceling the scheduled DSF.

A distribution can be Cash Distribution resulting from a Cash Dividend, Return of Capital, Sale of Rights, Security Sale or any Corporate Action Event where Cash is distributed to the holders of the Security/Depositary Receipt. MasterFile, stored in a database, provides a place to store Cash Distribution information centrally, instead of needing to refer to the deposit agreements and/or Issuer letter agreement every time the Cash Distribution/Dividend (Cash D/D) information is required. Domestic security regulations generally prohibit stock rights, e.g., stock splits or terminations that result in a stock sale, from being directly handled domestically for foreign stock. Instead, such events are handled, i.e., sold, locally in the originating country, and the resulting foreign cash received from this distribution is flowed through the system and is ultimately accounted for and distributed in the ADR account in MasterFile.

The CA Dividend/Distribution application may run a DR Program process which allows the RM and RH of the DR Programs to approve the Dividend/Distribution to be assessed at budget time, determine if a Cash D/D should be assessed or processed, view historical forecast and actual data, and update the Cash D/D. The System will also track and report on the Cash D/D Receivable and Payable accounts at the time of the Cash D/D Event(s), and the actual payments received.

In an embodiment, the system's cash D/D component may include the following features:
Calculating and displaying information in the Corporate Action application to enhance the Cash D/D process.
Update Corporate Action Cash D/D fields/values and displayed information with the most current data in MasterFile, CA Cash D/D;
Develop a Sub-Ledger accounting process, both for new clients and existing clients;
Develop Dividend Web Screen to Input/Update the Cash D/D information to be used for Cash D/D Events and Cash D/D Payments as well as Actual/Forecast screen for the RM and RH;
Create process for RM to make decision on assessing Cash D/D for their Financial Forecasting and Actual Accounting;
Create and approval process such that the RM/RH can determine whether a Cash D/D will be assessed for the Accounting process;
Create structure to store the Sub-ledger detail (incoming/Outgoing payments) in Corporate Action application;
Development of rules table for Corporate Actions that will effect the Cash D/D Events;
Systematically calculate Cash D/D on a Event basis;
Create process to remind RM to make decision on assessing Cash D/D (Event);
Create approval process such that the RH can determine whether a Cash D/D will be assessed (Event);
Enhance/Create announcement notifications for the Cash D/D Events;
Utilize the CA functionality to send announcement notifications to the Exchanges and Security Depositories;
Build an e-mail Cash D/D alert process to provide internal notification of upcoming Events (E-mail of daily and monthly Event R/Ds);
Allow the user to search by CUSIP or company name, and return summary information for issue plus list of dividends paid for that issue, and to input Tax Reclaim payments received, and an approver to approve the payments;
Create and enhance Cash D/D reports to accommodate the Financial, Reconciliation and Client reporting of the Cash D/D;
Track and systemically adjust the Cash D/D Events for Corporate Actions (Stock Splits, spin-offs, CUSIP changes) and Program life cycles.

At the time of a new Issuer/Program appointment, the DR Cash Dividend Fee rules may be set-up in MasterFile. In addition to the MasterFile set-up, the RM/D will need to validate the Cash Dividend/Distribution fee to be assessed in the Corporate Action applications. The CA Dividend Cash D/D screen should include the MasterFile fields and CA Dividend values in order to help the RM/D make the determination of the Cash D/D fee to be assessed. Once the rules are set-up in MasterFile and the CA Dividend application, the System will track, calculate and display the information using the most current data available. The MasterFile rules and the CA Dividend/Distribution information will be the driver for the CA Cash D/D Event processes. Periodically, e.g., each year, the RM/D may be notified that a Cash D/D re-certification is available and, if no action is taken, the System will use the pervious periods' information/data.

Once a CA DR Event is created for a Cash Dividend/Distribution, the Corporate Action application will perform a analysis on the Issuer/Program MasterFile Fee rules and the new fields/values from the Corporate Action Dividend application to determine if a Cash D/D fee will be assessed for the Cash Event. Once that determination is made, the CA Dividend application will do an analysis of the CA DR Events and will prompt the Dividend processor/approver whether the Cash D/D should/could be processed in conjunction with a DSF Event. If no other Event exists, the system will schedule the Cash D/D Event according to the Record Date. The CA Dividend application will need the flexibility to stop/cancel or modify a Cash Dividend/Distribution at anytime.

Once a CA DR Event is create for a Cash Dividend/Distribution, the Corporate Action application will perform a analysis on the Issuer/Program MasterFile Fee rules and the new fields/values from the Corporate Action Dividend application to determine if a Cash D/D fee will be assessed for the Cash Event. Once that determination is made, the CA Dividend application may be configured to do an analysis of the CA DR Events and will prompt the Dividend processor/approver as to whether the Cash D/D should or could be processed in conjunction with a DSF Event. If the Cash Event will also be assessing a additional fee, the system will schedule the Cash D/D Event according to the Record Date and include the fee information for the other Process It will also link the other events as a Parent and child process. The CA Dividend application will need the flexibility to stop/cancel or modify a Cash Dividend/Distribution at anytime.

There can be two processes for the Cash Dividend/Distribution payments process—the first will be an automated process in the cases when a Cash Event is paid in USD. On the payable date of the Cash Event, the Corporate Actions application may match the payment received from the Issuer or Custodian to the system generated Cash-to-be-received that was created on the Local Payable date of the Cash Event. The second process can be when a Cash Dividend/Distribution payment is paid in the Local Currency, as mentioned above. The Cash processor will verify the local currency payment was received from the Issuer Custodian in the Nostro account, and instruct the Corporate Action application to forward the FX contract to the FX Group. A “nostro account” is a bank account held in a foreign country by a domestic bank, denominated in the currency of that country. Nostro accounts are used to facilitate settlement of foreign exchange and trade transactions. In both cases the Corporate Action application will update and track the payments received to the funds anticipated and will update the Financial reports with the payment information and produce the tickets which will be input to the financial system.

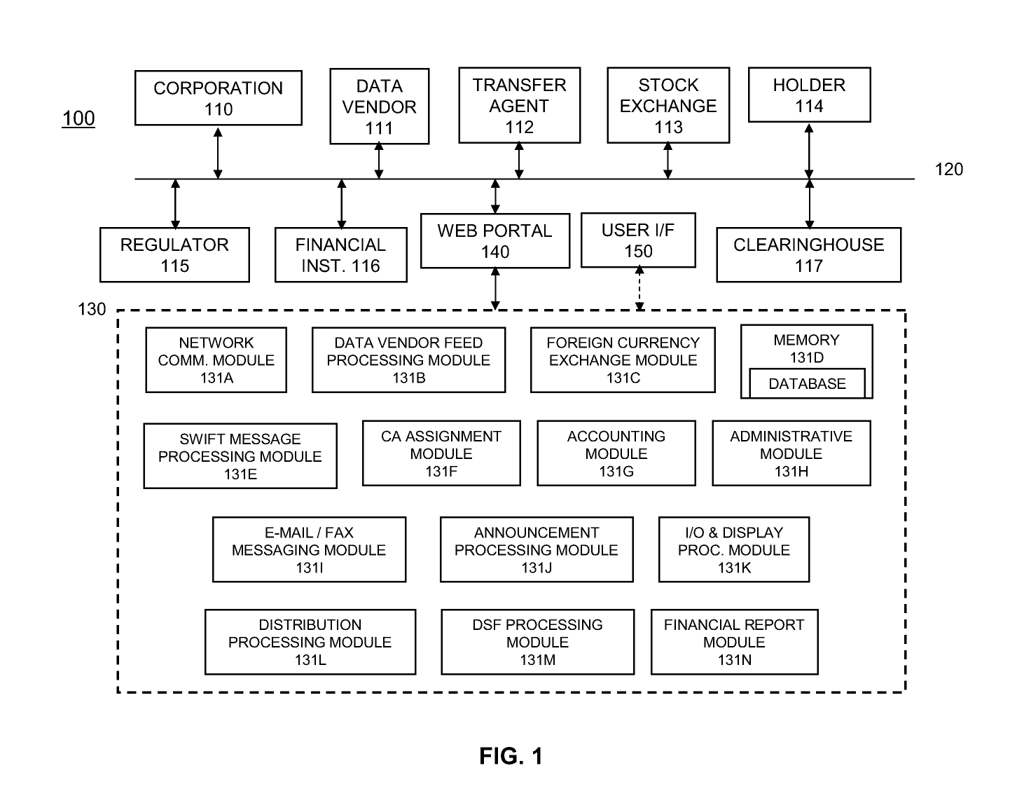

Turning now to the drawing figures, FIG. 1 illustrates an exemplary networked arrangement 100 which performs the various functions as described above, and in which various entities are in electronic communication with Corporate Action Data Processing System 130 (“system 130”) via network 120. These entities may be, for example, corporation (or issuer of CA) 110; third party data vendor 111 that provides financial information on a subscription basis, for example; transfer agent 112, responsible for making and receiving payments to/from holders; stock exchange 113 (e.g., the NYSE); security holder 114 (e.g., depositary receipt—“DR” holder), regulatory agency 115 (e.g., SEC), financial institution 116, (e.g., a bank or broker-dealer), and security clearinghouse 117 (e.g., DTCC, EuroClear, ClearStream). Web portal 140 may be configured to communicate between network 120 and system 130 to allow access to system 130 via the Internet, for example. User interface (“I/F”) 150 provides input/output capability for a user, and may include, for example, a keyboard and/or video display.

Data processing system 130 may be configured in various ways. For example, one or more specially configured processors and memories may be configured as functional “modules” which operate in accordance with various exemplary algorithms (discussed herein). The functional module depiction is not intended to be limiting, but merely provide an organized way to conceptually consider and implement the various functionality provided by data processing system 130 in accordance with generally accepted systems engineering practices.

To carry out the various functionality described herein, system 130 may include network communications module 131A, which handles communication of data to and from network 120 via known data protocols. Data vendor feed processing module 131B may be configured to receive financial information related to corporate actions, and received over network 120 from data vendor 111, for example, and to pass that information to other functional modules in system 130. Foreign currency exchange module 131C may be configured to process financial aspects of ADRs which require the conversion between one type of currency, e.g., the Euro, to the U.S. Dollar, or visa versa. Memory 131D may be implemented by various types of known memory devices, and may be configured to contain a structured database therein. Various data related to corporate action financial information and client information may be stored in the memory/database.

SWIFT message processing module 131E may be configured to parse incoming SWIFT corporate action messages, Message Type (MT) 564 Corporate action notification, MT 565 Corporate action instruction, MT 566 Corporate action confirmation, MT 567 Corporate action status and processing advice, and MT 568 Corporate action narrative, for example. MT 564 provides an account owner with details of a corporate action event and the choices available to the account owner. It also provides the account owner with details on the impact a corporate action event will have on a safekeeping or cash account, e.g., entitlement calculation. MT 565 instructs the custodian on the investment decision made by an account owner relative to a corporate action event. MT 566 confirms to the account owner that securities and/or cash have been credited/debited to an account as a result of a corporate action event. MT 567 indicates the status, or a change in status, of a corporate action-related transaction previously instructed by, or executed on behalf of, the account owner. MT 568 provides complex instructions or narrative details relating to a corporate action event.

CA assignment module 131F may be configured to electronically assign a particular incoming CA to the appropriate staff person or organization, e.g., a business administrator or relationship manager (RM), to review DR events that are created and/or processed through system 130.

Accounting module 131G may be configured, in conjunction with other functional modules of system 130, to process and store accounting ledger and sub-ledger entries in memory 131D. Such entries may include, for example, general ledger (GL) tickets, financial transactions, payments, accruals, automated account reconciliation (e.g., reconciliation document package—RDP), application-generated transactions, and automated balance updates to data in memory/database 131D, e.g., a so-called MasterFile.

Administrative module 131H may be configured to carry out various administrative functions, including, for example, approval and/or certification of DR events by the RM, or approval of a DR cash event by a dividend manager.

E-mail/Fax messaging module 131I may be configured to automatically parse and upload facsimile and/or e-mail contents received related to a corporate action to memory 131D, and provide notification to CA assignment module 131F.

Announcement processing module 131J may be configured to operate in conjunction with other functional modules of system 130 to automatically generate automated corporate action announcements in PDF, XML, XBRL, SWIFT and/or other formats to “the street”, e.g., exchanges and clearinghouses such as the London Stock Exchange (LSE), NYSE, DTC, EuroClear, and ClearStream.

Input/Output (I/O) and display processing module 131K may be configured to process keyboard or other standard input devices received from, for example, web portal 140 or User I/F 150, and to process outputs of system 130, e.g., print and/or video display outputs.

Distribution processing module 131L may be configured as described above to process corporate actions involving a cash distribution resulting from a dividend, including, for example, approximating dividends and applying dividend final rates. As mentioned above, cash distributions may also result from the exercise or sale of certain stock rights in the foreign jurisdiction, with cash flowing back through to the ADR.

DSF processing module 131M may be configured as described above, to determine DSF assessments and accruals, and to generate the necessary general ledger (GL) tickets associated therewith. Finally, financial report module 131N may be configured to provide various financial reports, described above, and in the Appendix to this disclosure.

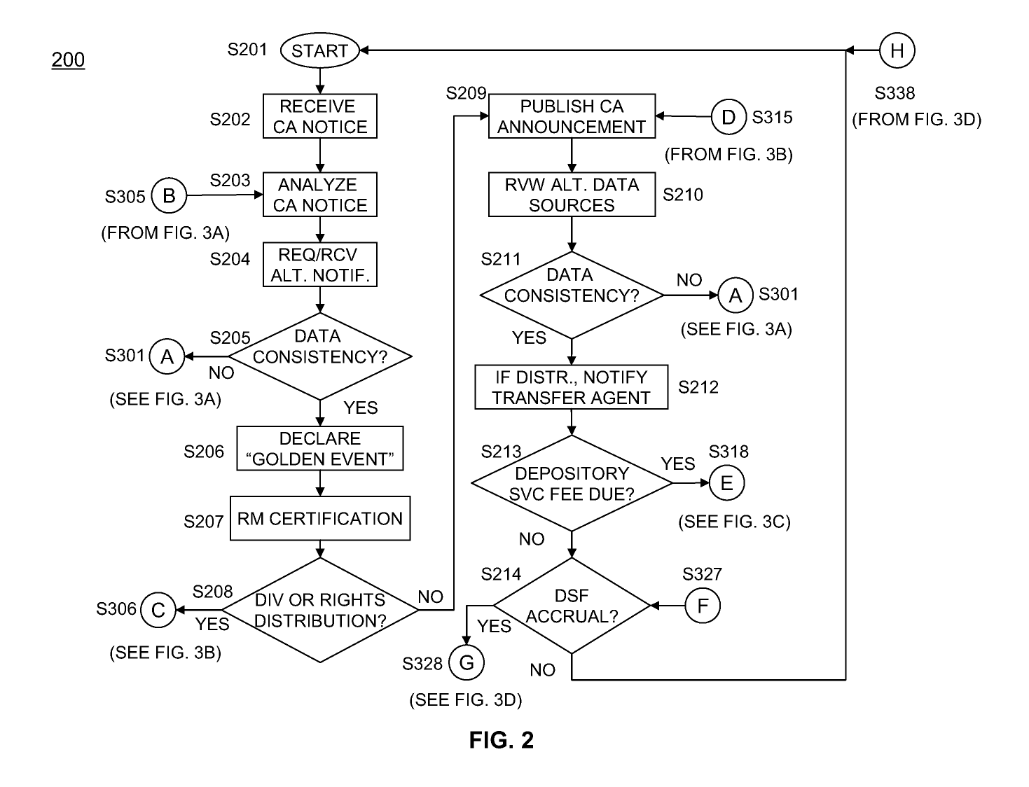

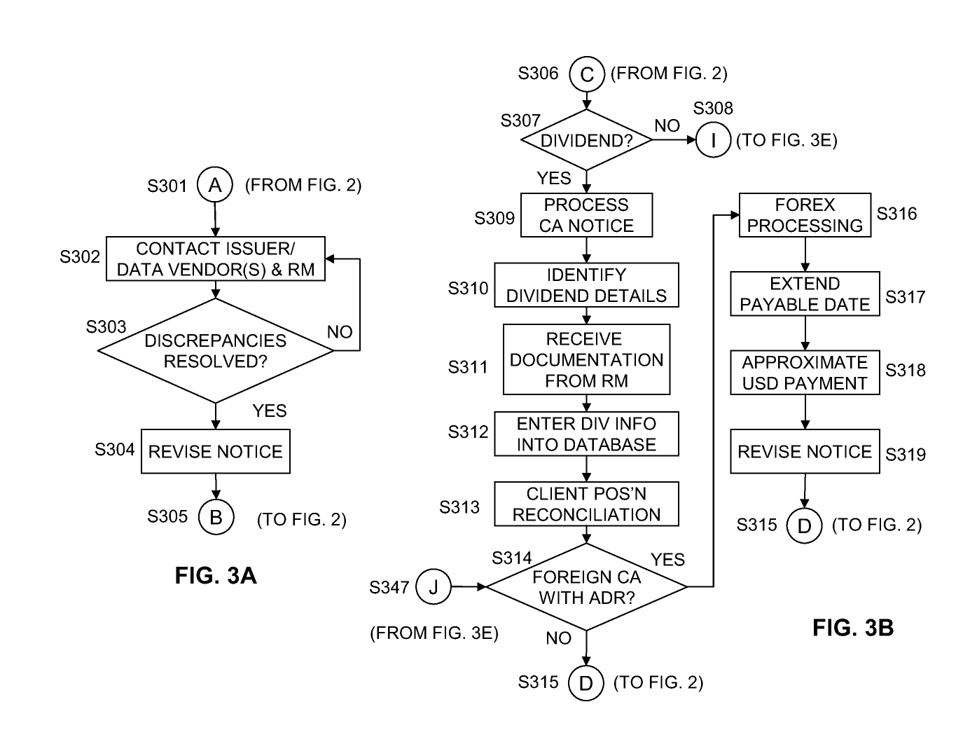

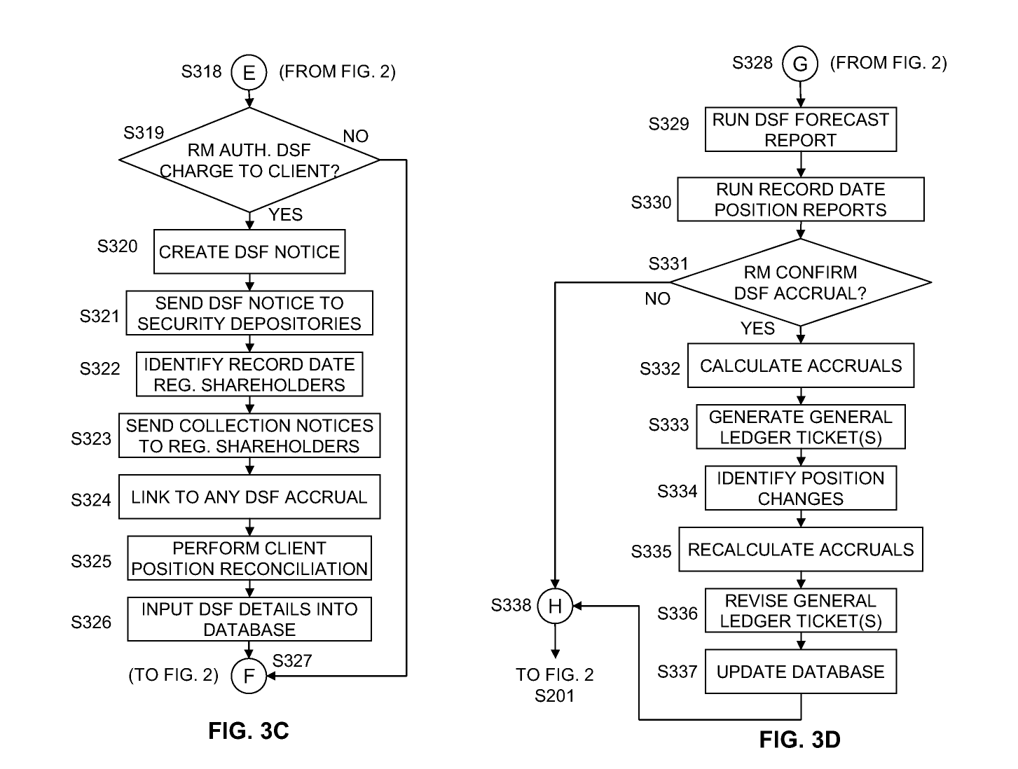

FIG. 2 provides an embodiment of an algorithmic flowchart of corporate action process 200. The process starts at step S201, and proceeds to step S202 where a CA notice is received from, for example, the issuer. Initial analysis of the CA is performed at step S203 to determine the type of corporate action. To ensure that the CA information is accurate, alternative notification is requested and received at step S204 from, for example, third party data vendor 111. Step S205 evaluates whether there is consistency between the data originally provided and the third party data. If the data is consistent, a “golden event” is declared at step S206. Following declaration of the golden event, a relationship manager (RM) provides certification of the CA event at step S207 to maintain financial control. Step S208 evaluates whether the CA involves a cash distribution, e.g., either a dividend or rights distribution resulting in the receipt of cash. If not, processing proceeds to step S209 where a CA announcement is published to “the street.” After publication of the CA announcement at step S209, alternative sources of data, e.g., from third party data vendor 111, are reviewed at step S210. If the data is determined to have remained consistent between the published data and the alternative data at step S211, then processing proceeds to step S212 where, if a dividend or other cash distribution is involved, transfer agent 112 is notified. Otherwise, processing continues to step S213, where evaluation of the CA is conducted to determine whether a DSF is due. If not, processing proceeds to step S214, where the CA is evaluated to determine whether the CA processing system should document a DSF accrual for imposition of a future fee. If not, processing is complete and may loop back to the start at step S201.

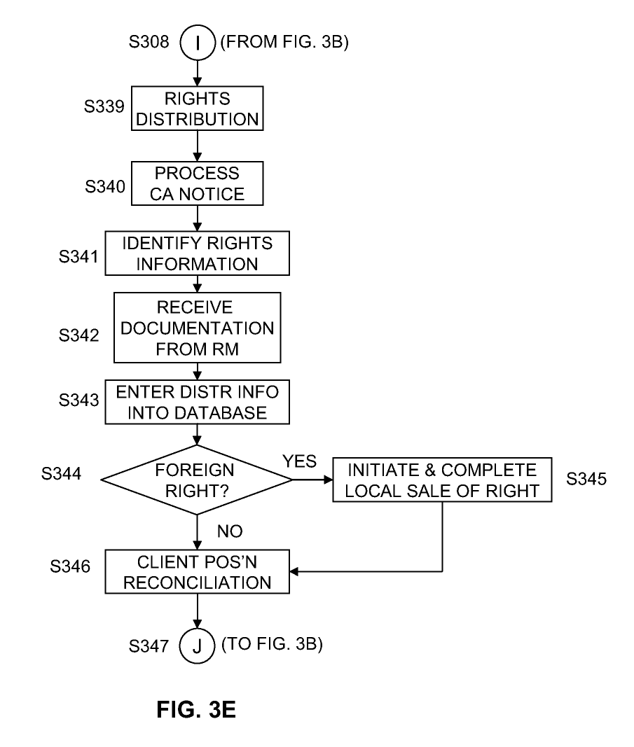

Alternatively, if CA data is determined at step S205 to be inconsistent, processing proceeds to step S301 in FIG. 3A. The issuer or corporation 110 and data vendor 111 are contacted at step S302, and processing remains at step S302 until discrepancies are resolved at step S303. After all discrepancies in the information are resolved, the CA notice is revised at step S304, and processing proceeds to step S305, and then back to CA analysis at step S203 in FIG. 2, where processing proceeds as described above.

Alternatively, if the CA notice involves a distribution at step S208 in FIG. 2, e.g., a dividend distribution or rights distribution resulting in the receipt of cash, then processing proceeds to step S306 in FIG. 3B, and continues to step S307 where the type of distribution is determined, i.e., a dividend or rights distribution. If the distribution is a cash dividend, processing continues to step S309 where the CA notice is processed. At step S310, dividend details are identified, and any pertinent documentation is received from the RM at step S311. After confirming the dividend or distribution details, the dividend/distribution information is entered at step S312 into the database in memory 131D, e.g., in the MasterFile. The client's security position is reconciled at step S313 to account for the distribution/dividend. If the distribution is determined at step S314 to be involved with a foreign CA associated with an ADR, processing proceeds to step S316, where foreign exchange (FOREX) processing is conducted. Due to the vagaries and uncertainties involved with future FOREX transactions, the distribution payable date is extended at step S317 beyond the original due date of the underlying foreign stock. In addition, an approximate payment amount in U.S. dollars is determined at step S318. As a result of the FOREX implications of the corporate action, the CA notice is revised accordingly at step S319. Processing then proceeds to step S315 in FIG. 2, where processing proceeds as described above.

Alternatively, if no foreign CA is involved at step S314, then processing proceeds to step S315 in FIG. 2, where processing continues at step S209 by republishing the CA announcement. Again, if data inconsistency arises at step S211, processing proceeds to step S301 in FIG. 3A, as described above.

Alternatively, if a DSF fee is due at step S213, then processing proceeds to step S318 in FIG. 3C, and then to step S319 where the RM provides authorization to charge a DSF or not. If the DSF is authorized, processing proceeds to step S320 where a DSF notice is created, and sent electronically to the relevant securities depositories at step S321. If the DSF is not authorized, then processing proceeds to step S327 in FIG. 2. Otherwise, the record date is identified for registered shareholders at step S322 and stored in the MasterFile in memory 131D, followed by sending a collection notice to the registered shareholders at step S323. Step S324 links the DSF to any DSF accrual that may have previously been determined and stored in memory 131D. The client's position is reconciled at step S325, and details of the DSF are input into the database, e.g., MasterFile, at step S326. Processing then proceeds to step S327 in FIG. 2.

Alternatively, if a DSF accrual pertains at step S214, processing proceeds to step S328 in FIG. 3D where a DSF forecast report is run at step S329, and record date position reports are run at step S330. At step S331, the RM confirms if a DSF accrual should be applied to the particular client. If not, processing proceeds to step S338 and then to step S201 in FIG. 2. If DSF accrual pertains, then the accrual is calculated at step S332, and general ledger (GL) ticket(s) are generated at step S333. Any client position changes are identified at step S334, which may require a recalculation of the accruals at step S335. If necessary after recalculation, the GL ticket(s) are revised at step S336. The database, e.g., MasterFile, is updated at step S337, and then processing proceeds to step S338 and then to step S201 in FIG. 2 where the process may start again, or may terminate.

Returning to FIG. 3B, if the distribution at step S307 is a rights distribution and not a dividend, processing proceeds to step S308 in FIG. 3E. Rights distribution processing begins at step S339, and proceeds to step S340 where the CA notice is processed, and the specific rights are identified at step S341. Documentation regarding the rights distribution is received from the RM at step S342. Distribution information is entered into the MasterFile in the database at step S343. A determination is made at step S344 as to whether the underlying stock rights being exercised are non-domestic, foreign rights. Since these foreign rights generally may not be exercised outside the local jurisdiction due to security regulations, a local sale or execution of rights is initiated locally at step S345. A local transfer agent may be utilized for this purpose. Once the local sale has completed and foreign currency cash amount identified, the client's position is reconciled at step S346. Processing then proceeds to step S347, which returns to the processing described with respect to FIG. 3B at step S314.

In the description above, data transmission may occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computing device having a display device. The display device can, for example, be a cathode ray tube (CRT) and/or a liquid crystal display (LCD) monitor, and/or a light emitting diode (LED) monitor. The interaction with a user can, for example, be a display of information to the user and a keyboard and a pointing device (e.g., a mouse or a trackball) by which the user can provide input to the computing device (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computing device having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computing devices and having a client-server relationship to each other.

Communication networks can include packet-based networks, which can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

The computing device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a World Wide Web browser (e.g., Microsoft® INTERNET EXPLORER® available from Microsoft Corporation, of Redmond, Wash.). The mobile computing device includes, for example, a Blackberry® provided by Research In Motion Limited of Waterloo, Ontario, Canada.

Comprise, include, and/or plural forms of each are open ended and include the listed parts and can include additional parts that are not listed. And/or is open ended and includes one or more of the listed parts and combinations of the listed parts.

Various embodiments may be described herein as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

### APPENDIX

Table I provides a listing of exemplary actions for the CA platform, identified as numbered “business requirements” or “objectives” (“BR”).

TABLE I
Corporate Action Processing Functionality

| Objective | Description |
|---|---|
| BR.01 Creation of DR | The DR Event may contain all the user-defined required and optional fields specific to |
| Event | the DR corporate action type (most will differ from the existing list of underlying |
| | corporate action types). |
| BR.02 ‘Created’ and | Each DR corporate action event profile may have a ‘Created’ and ‘Updated’ name and |
| ‘Updated’ name and | date/time stamp and may have the ability to capture history such that users can access |
| date/time stamp | it to determine who saved a change to the profile and when it was changed. |
| BR.03 Creation of DR | For DR Events that are to be created off existing underlying events, functionality is |
| Event from existing | provided so that, at the time the underlying event is approved, the approver is required |
| Underlying Event | to indicate whether a DR Event is needed. If so, they are prompted to pick the DR |
| | Event that they want and the CUSIP(s) that the corporate action pertains to. |
| BR.04 Creation of DR | For corporate actions that are not driven by events in the home market, DR Events |
| Event as a stand alone | may be created without an originating underlying event. Corporate actions such as |
| event | ratio changes and terminations will be DR-only events since they are specific to the |
| | DR program. |
| BR.05 Link a created | For corporate actions that may be confidential, where the announcement has not yet |
| DR Event back to an | occurred in the home market, there is a need to create the DR Event first, work on it |
| Underlying Event | and then go back and attach the Underlying Event to it. |
| BR.06 Multiple CUSIPs | Corporate actions may occur on a single security in the home market which affects |
| on a single DR Event | multiple DRs backed by that same security. As a result, when selecting the CUSIP for |
| | the DR Event, all of the Active and Effective CUSIPs backed by the ISIN on the |
| | Underlying Event need to be displayed and multiple values may be selected, regardless |
| | of the status of the DR. |
| BR.07 Create DR Events | Since the termination period for DRs can be a year or longer, there are times when |
| for Terminated DRs | corporate actions can be done on terminated DRs to ensure accurate settlement and |
| | reconciliation processes. These corporate actions would be completed internally and |
| | generally would not be announced to the street. |
| BR.08 Approval of DR | All fields entered on the DR Event should be approved by an authorized user who did |
| Events | not enter the data. The approval information (old and new values for all of the fields |
| | updated with the user's name) should be captured in the audit log history within both |
| | the CA application and within MasterFile for those fields that are currently ‘corporate |
| | actioned’ in MasterFile (DR Name, CUSIP, ratio, etc.). The approvals should be done |
| | by a DR Control Group which currently only has inquiry access to the CA application. |
| BR.09 Document | Documents should be created in the Corporate Actions application for most corporate |
| Creation | actions and therefore the information needs to formatted per the template rules. |
| BR.10 Feed Corporate | The new values for ‘corporate actionable’ fields (DR Name, CUSIP, ratio, etc.) which |
| Action data to MasterFile | will be approved on the DR Event within the CA application need to be sent to the |
| on the Effective Date | MasterFile on the Effective Date of the corporate action. |
| BR.11 Simultaneous DR | An e-mail needs to be created and sent to the processing areas (Dividends, Global |
| Event E-mail | Corporate Action Team (GCAT) and Proxy) when there is more than one pending DR |
| | corporate action event for the same CUSIP/CUSIPs to ensure that they are aware of |
| | what the other areas are working on that might impact their corporate action (pending |
| | cash dividend and pending ratio change). |
| BR.12 Related DR | When there is more than one corporate action occurring simultaneously, a link needs |
| Events | to be built between the DR Events in the CA application (Name change and forward |
| | split). This functionality should facilitate generating a single corporate action |
| | announcement document. |
| BR.13 One Underlying | There are instances where complex corporate actions in the local market may be |
| Event maps to multiple DR | conveyed in a single SWIFT message by the custodian. The single Underlying Event |
| Events | was approved, but multiple DR Events should be created for each of the corporate |
| | actions (For example, a “Conversion” Underlying Event effects a par value change, a |
| | reverse split and a cash distribution on the DR side, each of which needs to be a DR |
| | Event). |
| BR.14 Multiple | There are instances when custodians and other sources send notifications coded |
| Underlying Events map to | differently for the same event, the multiple underlying events are approved, but since |
| one DR Event | they reflect the same transaction, they should be merged into a single DR Event. |
| BR.15 Event Owner | An individual's name needs to be selected as the DR Event Owner from the list of |
| | people's names assigned to the “Owner” group from the Underlying Event. |
| BR.16 Termination E- | Generate an e-mail tickler that provides an alert prior to the initial sale date (e.g., 3 |
| mail tickler | weeks) for terminated DRs that remaining shares need to be sold to make the final |
| | payout to DR holders. |
| BR.17 Ability to | A free format text box must be available for users to add comments. Any changes |
| associate additional | saved to this section must update the “Updated” name and date/time stamp on the |
| business data with the DR | underlying security corporate action event profile. |
| corporate action event | |
| BR.18 Move the existing | Dividends Approximate and Final Letters - The existing Approximate and Final |
| DR Ops | dividend letters in the DR Ops - Dividends application need to be moved out of there |
| | to be replaced by documents in the Corporate Actions Application after the |
| | Approximate and Final screens have been approved in DR Ops - Dividends. |
| BR.19 Allow Books | The Books Closed functionality that currently exists in MasterFile needs to be added to |
| Closed functionality/ | the Corporate Actions application for GCAT and Dividends processing purposes. |
| update | |
| BR.20 Allow indexing of | Notifications and documents need to be able to be indexed to an Underlying Event or a |
| notifications/documents to | DR Event. |
| the DR Event | |
| BR.21 Inquiry screen | An “inquiry” screen is required in order to research DR corporate actions by name, |
| | CUSIP, DR ISIN, corporate action event, event date, date received, record date, |
| | payment date, ticker symbol, etc. A “full search” capability is needed to find all |
| | pending, rejected, finalized, or cancelled items. |
| BR.22 Reports | Reports need to be created to allow users to export the results of the query into excel |
| | for further analysis. |

Table II provides a listing of exemplary actions for Depositary Service Fee (DSF) processing in the CA platform, identified as numbered “DSF requirements” or “objectives” (“DSF”).

TABLE II
Corporate Action Depositary Service Fee (DSF) Functionality

| Objective | Processing Description |
|---|---|
| DSF1.0 | Modify and/or add fields in MasterFile and Design Fields and/or calculate and display values in CA |
| | Dividend DSF application from the historical and current data in order to facilitate the DSF Accrual |
| | Accounting and DSF Event Process. |
| | DSF1.1 The last DSF Event date (if available) will be used to calculate DSF assessment date. If no |
| | DSF Event date, then the Issuer/Program start date in MasterFile will be used to calculate DSF |
| | assessment date. |
| | DSF1.1.1 Forecast DSF Record Date (YYYYMMDD), Calculated by CA Dividend System/over- |
| | ride RM |
| | DSF1.2 DSF Service period (YYYYMM) to (YYYYMM), Calculate from DR-Ops/CA Dividends. |
| | DSF1.3 Forecast DSF Fee Rate (value), Calculated by CA Dividend System/over-ride RM. Must be |
| | equal to or less then MasterFile Annual Maximum. |
| | DSF1.3.1 Modify MasterFile to include the maximum Fee for DSF as outlined in the Deposit |
| | agreement and Letter agreement (Event and per annum). MasterFile solution - change existing |
| | MasterFile DSF field to “Annual Depositary Service” Fee. |
| | DSF1.3.2 Modify MasterFile to include the maximum Cash distribution Fee as outlined in the |
| | Deposit agreement and Letter agreement (Event and per annum). MasterFile solution - add field in |
| | MasterFile (Annual Cash Div Fee Cap). |
| | DSF1.3.3 Add field(s) to MasterFile in order to accommodate a maximum Cash distribution fee and |
| | a maximum DSF combination as outlined in the Deposit agreement and Letter agreement (per |
| | annum). MasterFile solution - add field in MasterFile (Annual DSF & Cash Div Fee Cap) |
| | DSF1.4 Total Cash distribution Fee assessed (value); (Current and Prior service period) Default 0 |
| | for a new Issuer/program and calculated from current available data for existing programs. For |
| | Forecast (to be assessed) default to MasterFile Fee. |
| | DSF1.4.1 Total Cash Distribution Fee assessed (value); (Current and Prior service period) Default 0 |
| | for a new Issuer/program and calculated from current available data for existing programs. For |
| | Forecast (to be assessed) default to CA Fee. |
| | DSF1.5 Total DSF Fee assessed (value). (Current and Prior service period) Default to 0 for a new |
| | Issuer/program and calculated from current available data for existing programs. For Forecast (to be |
| | assessed) default to MasterFile Fee “Annual Depositary Service - Issuer Negotiated Fee” |
| | DSF1.6 Total available Fee to be assessed (value), (Current and Prior service period) Default to 0 |
| | for a new Issuer/program and calculated from current available data for existing programs. For |
| | Forecast (to be assessed) default to MasterFile Fee “Annual Depositary Service - Issuer Negotiated |
| | Fee” |
| | DSF1.7 Total Stock Dividend assessed (value) (Current and Prior service period) Default to 0 for a |
| | new Issuer/program and calculated from current available data for existing programs. |
| | DSF1.8 Total Rights Fee Assessed (value) (Current and Prior service period). Default to 0 for a new |
| | Issuer/program and calculated from current available data for existing programs. |
| | DSF1.9 Assess DSF with Cash Event (Cash distribution, Rights, Termination) (Y/N). |
| | DSF1.10 Multi-DSF Event (Y/N) If yes, number of Events (value). |
| | The Multi Events will always be in equal proportions to the Fee being applied, including |
| | percentages. |
| | DSF1.11 Negotiated Fee holders (Y/N) If yes, number of shares held by Negotiated Fee holder(s) |
| | (value) DSF Fee to apply to Negotiated Fee holders (Value). The Negotiated Fee rate will need to be |
| | in proportion to Fee being applied in Multi Events. |
| | DSF1.12 DSF Revenue Sharing (Y/N) If yes, percentage. |
| | DSF1.13 A warning message needs to be given to the Dividend and DSF processor at the time of a |
| | DR Event being created, on both the DR-Ops and the CA application. If a conflict on Dividend fee |
| | and DSF fee exist when the Net DSF from Cash Distribution field is (Y) or when there is an annual |
| | Cap on Cash and DSF. The Processor should NOT be able to override the MasterFile DA fee limits |
| | that results in a greater fee then what is allowed in the DA. |
| | Note: The new DSF display values will be updated with the most current data available in |
| | MasterFile, CA and DR-Ops. A Cash distribution, Stock, Rights, Cash distribution, DSF Event |
| | which is Approximate and/or Final approved will effect the values. |
| DSF2.0 | Create a CA Dividend Web Screen which will pull data from MasterFile, CA and DR-Ops that the |
| | Relationship Manager (RM) or Designee (D) can view and input into, so that; the required DSF |
| | values can be updated when a new Issuer/program is established or at the time of RM is budget |
| | forecasting for the subsequent year. |
| | The screen should allow the RM/D to set-the DSF rules which will determine the DSF to be |
| | assessed and will be “Driver” for the DSF Accrual Accounting and DSF Event process. |
| | In addition, it should allow the RM/D to make a decision on assessing DSF Fee prior to the DSF |
| | Event and allow manual overrides to cancel and reinstitute DSF Fee accruals & events. |
| | Warning messages and Security locks (RACF) are required on the screen, so that; only authorized |
| | personnel can input or make changes. |
| | The Screen should allow the RM/D to view and update the prior and current year parameters and |
| | input forecast data for the upcoming year; which will be updated with the Actual fees information as |
| | Events are processed on either DR-Ops or CA Dividends. |
| | The Screen should also allow the user to navigate by a click of her/his mouse between the DR |
| | Approval Queue, Corporate Actions, MasterFile, Billing, IMMR and Reconciliation Web |
| | applications and the screens and reports of the CA Dividend DSF application. |
| DSF3.0 | Create an approval process for the Regional Head (RH) or Designee to approve the RM/D input to |
| | the required DSF Web screen when a new Issuer/program is established and/or if the RM/D updates |
| | the required DSF information. |
| | An RH/D can override whether a DSF will be assessed; by rejecting the information the RM/D(s) |
| | inputted into the required DSF process screen. A reject message (e-mail) should be sent to the |
| | RM/D stating the DSF information has been reject and requires updates. A comments field is |
| | required so that the RH/D can comment on what needs to be adjusted by the RM/D and/or which |
| | fields require his/her attention. The RH/D should be able to mark a reject, make a comment on that |
| | reject and approve the remainder of the DSF to be assessed. |
| | Warning messages and Security locks (RACF) are required on the process/screen, so that; only |
| | authorized personnel can make changes. |
| | The Screen should allow the RH/D to view the prior and current year statistics and input forecast |
| | data for the upcoming year; which will be displayed with the Actual fees information as Events are |
| | processed on either DR-Ops or CA Dividends. |
| | The Screen should also allow the user to navigate by a click of her/his mouse between all of the DR |
| | Web applications as outlined in DSF2.0 and the screens and reports of the CA Dividend DSF |
| | application. |
| DSF4.0 | Develop Accrual Accounting; both for new clients and existing clients utilizing the current DSF |
| | fields in MasterFile the values from the CA application and the calculated values in the CA DSF |
| | application. |
| | DSF4.1: If the MasterFile “Annual Depositary Service fee'” = (blank or 0) No Action taken |
| | DSF4.2: If the MasterFile “Annual Depositary Service’ = (>0) and MasterFile Annual Depositary |
| | Service - Issuer Negotiated Fee = (blank or 0) No Action taken. |
| | DSF4.3 MasterFile “Annual Depositary Service’ = (>0) and MasterFile Annual Depositary |
| | Service - Issuer Negotiated Fee = (>0) Accrual accounting is required. |
| | DSF4.3.1: If MasterFile field “Net DSF from Cash distribution” = (N) use (new Field) DSF Fee to |
| | be assessed and multiplied by outstanding share balance (2^{nd} business day from month-end) to get |
| | total DSF Fee for the service period; Divide total DSF by months of service to get total monthly |
| | Accruals (e.g. .02 DSF Fee to be assessed × 50,000,000.0000 shares = $1,000.000.00 Total DSF/ |
| | 12 months = $83,333.33 Accrual per month) Note: The DSF Fee Accrual is calculated on the |
| | number of months (inclusive of program start/end month) the DR Division is providing services to |
| | the program in any given year. So, if a program is established in March then the number of months |
| | would be decreased; which would increase the monthly Accruals (e.g. .02 × 50,000,000.0000 share = |
| | $1,000.000.00/10 months = $100,000.00 per month) (See Attachment J) |
| | DSF4.3.2: If MasterFile field “Net DSF from Cash distribution” = (Y) use Total Fee available to be |
| | assessed (value) instead of DSF Fee to be assessed for the calculations as in B4.0.3.1. If the Total fee |
| | available to assess is 0 then No Action is needed. If Total Available fee to be assessed is greater |
| | then 0 (e.g. Total Available fee to be assessed. = .01 × 50,000,000.0000 share = $500.000.00/12 |
| | months = $41.666.66 per month) Note: The DSF is calculated on the months the DR Division is |
| | providing services to the program in any given year. So, if a program were established in March |
| | then the number of months would be decreased which would increase the monthly Accruals (e.g. .01 × |
| | 50,000,000.0000 share = $500.000.00/10 months = $50,000.00 per month). Note: Accrual |
| | Accounting will be re-calculated each month on the 2^{nd} to last business day from the end of the |
| | month utilizing the previous days balance. |
| | MasterFile changes due to the MasterFile solutions in DSF.1 |
| | DSF4.4 Net DSF from Cash distribution’ equals Y, ‘Annual DSF and Cash Div Fee Cap’ is blank, |
| | and ‘Annual Cash Div Fee Cap’ is blank: Each Cash distribution fee cannot exceed the ‘Cash |
| | distribution’ Fee, but the DSF must be subtracted from the Cash distribution fee(s) for the year. |
| | DSF4.4.1 Net DSF from Cash distribution’ equals Cash, then DSF must be not be assessed, if there |
| | is ANY Cash distribution fee charged for the service period. Once a cash Distribution fee is |
| | assessed for that service period the DSF Accrual will be reversed for the service period. |
| | DSF4.5 Net DSF from Cash distribution’ equals N, ‘Annual DSF and Cash Div Fee Cap’ is entered, |
| | ‘Annual Cash Div Fee Cap’ is blank: |
| | Total Dividend and DSF for a year cannot exceed ‘DSF and Cash Div Fee Annual Cap’. The DSF |
| | fee in a year cannot exceed ‘Annual Deposit Agreement’, and each Cash distribution cannot exceed |
| | the ‘Cash distribution’ fee. |
| | DSF4.6 Net DSF from Cash Div’ equals N, ‘Annual DSF and Cash Div Fee Cap’ is blank, and |
| | ‘Annual Cash Div Fee Cap’ is entered: |
| | Total Cash distribution fees for a year cannot exceed ‘Annual Cash Div Fee Cap’. The DSF fee in a |
| | year cannot exceed ‘Annual Deposit Agreement and each Cash distribution cannot exceed the ‘Cash |
| | distribution’ fee. |
| | DSF4.7 Net DSF from Cash Div’ equals Y, ‘Annual DSF and Cash Div Fee Cap’ is blank, and |
| | ‘Annual Cash Div Fee Cap’ is entered: |
| | Total Dividend Fees for a year cannot exceed the ‘Annual Cash Div Fee Cap’, and each Cash |
| | distribution cannot exceed the ‘Cash distribution’ fee. DSF must be subtracted from the Cash |
| | distribution fee(s) for the year. All of the Fees in MasterFile will be increased from 2 decimal places |
| | to 4 decimal place. The CA DSF application will need to accommodate this change. |
| | Rule-Blank and No equal the same |
| DSF5.0 | Create structure to store the Accruals in Corporate Action Dividend application DSF component. |
| | Tracking of the DSF Receivables (Accrued, Billed) DSF Payables (Issuer, Bank), DSF Incomes |
| | (Issuer, Bank) DSF billed, DSF Collected, DSF outstanding for each Program and CUSIP. |
| | Authorized personnel should be able to view this data and run reports by Region, Program, CUSIP, |
| | Record Date, Billed Date, Payment Received Date, Dollar amount and by each of the tracked |
| | values. |
| DSF6.0 | Systematically calculate and adjust Accruals on a monthly basis in the Corporate Action Dividend |
| | Application DSF component. Note: Accrual Accounting will be re-calculated each month on the |
| | 2nd business day from the end of the month utilizing the previous days balance and requirements |
| | outlined in B4.0. |
| | DSF6.1 If the Total Accrual for this month is the same as last month's (Share position and DSF rate |
| | applied = last month's) then only add this month's Accrual to DSF Application and write this |
| | month's accrual amount to financial ticket and reports |
| | DSF6.2 If the Total Accrual for this month is the different from last month's (Share position and |
| | DSF rate applied < > last month's) then adjustments to the accruals for accrual period are required |
| | Add new calculated Accrual to the current month's on DSF Application. Also, make an adjustment |
| | for all “old accrual amounts (debit/credit) and write the accrual amounts on financial tickets and |
| | reports. |
| | Note: There are exceptions to the adjustments to the Accrual Process outlined in DSF.6.1 and |
| | DSF6.2. When a DSF Event is processed in the current year and that year's Service Accrual period |
| | extends out passed the Event Date, then the following rule applies: |
| | DSF6.3 If the DSF Event has been run for the current year and the new MasterFile field DSF |
| | Assessment year; equals Current year; then the DSF Accrual period extends past the Event date. In |
| | this case use the DSF Event Dates Record Date position times the DSF Event Rate to calculate all |
| | Accrual amount. Add this month's Accrual to DSF Application and write this month's accrual |
| | amount to financial ticket and reports (e.g. DSF assessment period = 2009; DSF Event date = |
| | Jan. 15, 2009 use Jan. 15, 2009 record date position * DSF rate applied to Event = Accrual amount for January 2009 |
| | thru December 2009) |
| | Interim and Restricted CUSIPs need to be accrued for and have a DSF Event in conjunction with the |
| | Primary CUSIP. The Interim CUSIP will fold into the Primary CUSIP after period of time (usually |
| | with in 40 to 60 days). |
| DSF7.0 | Create financial transaction tickets that will be input into the Banks Financial System for the DSF |
| | Accruals. This will entail creating the tickets for the initial DSF Accruals and the Monthly |
| | adjustment. (See attachment H) |
| | DSF7.1 Fees on behalf of the previous year |
| | When a DSF Record Date is on behalf of a prior year's service (ex: you are in 2009, but the fee |
| | period you're charging for is 2008) any funds collected in 2009 will be credited to receivable |
| | account (1744156 + reference) tied to charged Issuer. If the collected amount is greater than the |
| | amount in the receivable, the remaining balance will be credited to the income account (7625983) If |
| | the collected amount is less than the amount in the receivable, the remaining balance in the |
| | receivable will need to be credited by DEBITING the DSF Income account (7625983) This should |
| | not affect the concurrent accrual for 2009 services that occurs within that collection period. So, if |
| | funds are collected on behalf of 2008 services, the process of debiting receivables and crediting |
| | income each month to recognize “earned revenue” would not change for the accrual of 2009 |
| | services. |
| | DSF7.2 Fees on behalf of the current year |
| | When a DSF Record Date is on behalf of the current year's services (ex: you are in 2009, and the fee |
| | period you're charging for is 2009) then any funds collected in 2009 will be credited to the |
| | outstanding receivable. The funds collected will be greater than the outstanding receivable (since the |
| | accrual period hasn't matured yet) and therefore any excess funds should be credited to the DSF |
| | Payable Account (2720319 + reference). Going forward, instead of debiting a receivable for each |
| | month's “earned income”, the payable account will be debited and the income account will be |
| | credited. |
| | In addition, these Financial tickets should be in proof (Total Debits = Total Credits). |
| | Note: This requirement might change slightly as a result of the Division discussion with the Bank's |
| | Financial Group. |
| DSF8.0 | Create a report of the Accruals (detail and totals), the adjustments to the Accruals (details and totals) |
| | and the Actual DSF assessments. The report should be produced monthly at the time of the |
| | adjustments and is available ad-hoc. |
| | Authorized personnel should be able to view this data and run reports by DSF assessment periods |
| | (From, To), Program, CUSIP, DR Name, DR Status, Country of Management, Region, Relationship |
| | Manager New York, Relationship Manager, Unsponsored Administrator and should be able to be |
| | sorted by each of the tracked values. The Primary, Interim, and Restricted, as well Bifurcated |
| | CUSIPs should be displayed on the reports with their related programs. |
| | The Monthly Accrual Adjustment Report should include the Detail and Totals of the Financial |
| | Transactions that are posted on the Financial Transaction tickets. |
| | The Report should also available in an Excel format. |
| DSF9.0 | Develop DSF Event Process; both for new clients and existing clients utilizing the current DSF |
| | fields in MasterFile and the calculated value requested in CA Dividend. Create DSF Event |
| | Scheduler |
| | DSF9.1: If the MasterFile “Annual Depositary Service fee'” = (blank or 0) No Action taken |
| | DSF9.2: If the MasterFile “Annual Depositary Service’ = (>0) and MasterFile Annual Depositary |
| | Service - Issuer Negotiated Fee = (blank or 0) No Action taken. |
| | DSF9.3 MasterFile “Annual Depositary Service’ = (>0) and MasterFile Annual Depositary |
| | Service - Issuer Negotiated Fee = (>0) and CA DSF application charge DSF = Y; then DSF Event |
| | Process is required. |
| | DSF9.3.1: On the 5^{th} to last business day of each month search the DSF Forecast R/D. If the DSF |
| | Event month is two months from current month (e.g. Current month = April and DSF Forecast R/D |
| | month = June, then pull CUSIP into DSF Event Scheduler). |
| | DSF9.3.1.1 IF “Net DSF from Cash distribution” = (N) use (CA Forecast DSF rate) DSF fee to be |
| | assessed as the DSF fee in the DSF Event to be sent to the DR Holders of Record and Add CUSIP to |
| | the DSF Event Schedule Note: If field (DSF fee to be assessed) is 0 no Action is required. |
| | DSF9.3.1.2“Net DSF from Cash distribution” if = (Y) use (calculated value) Total Fee available to |
| | be assessed as the DSF Fee in the DSF Event to be sent to the DR Holders of Record and Add |
| | CUSIP to the DSF Event Schedule. Note: If field is 0 no Action is required |
| | DSF9.3.1.3 Net DSF from Cash distribution equals “Cash” then the DSF must be not be assessed if |
| | there a Cash distribution fee charged for the service period. Once a cash Distribution fee is assessed |
| | for that service period, the DSF Event will be rescinded for the service period. |
| | DSF9.4 The RM will be notified 60 day from anticipated R/D of the upcoming DSF event, at this |
| | time they can change the charge Flag to N if they do Not want to access the DSF or they can modify |
| | the R/D if they so chose. If they change the charge flag then the accrual will be reversed. If they |
| | modify the R/D then it must be at least 30 day from current. The only exception will be if the service |
| | period's end date is 12 months from the new R/D then the System will advise the RM of the error |
| | and not proceed. Note: all modifications and changes will need to be approved by the RH or |
| | designee. |
| | Interim and Restricted CUSIPs need to be accrued for and have a DSF Event in conjunction with the |
| | Primary CUSIP. |
| | Once all Issuer/Program and DSF Fees to be assessed have been identified for the month and added |
| | to the DSF Schedule, the DSF Events should be created in Corporate Action. |
| | Information required-DSF Assessment year, Issuer Name, CUSIP, DSF Fee, Depositary and |
| | Security Type. For DTC BNYM DTC number. Note: Currently notice MUST be given to the |
| | Security Depositories (DTC, ClearStream and EuroClear) and put out on the DR Website 30 day |
| | prior to the record date of the DSF assessment. |
| | The below changes due to the MasterFile solutions in B.1 have been addressed in Phase I |
| | DSF9.5 Net DSF from Cash distribution’ equals Y, ‘Annual DSF and Cash Div Fee Cap’is blank, |
| | and ‘Annual Cash Div Fee Cap’is blank: Each Cash distribution fee cannot exceed the ‘Cash |
| | distribution’ Fee, but the DSF must be subtracted from the Cash distribution fee(s) for the year. |
| | DSF9.6 Net DSF from Cash distribution’ equals N, ‘Annual DSF and Cash Div Fee Cap’is entered, |
| | ‘Annual Cash Div Fee Cap’is blank: |
| | Total Dividend and DSF for a year cannot exceed ‘DSF and Cash Div Fee Annual Cap’. The DSF |
| | fee in a year cannot exceed ‘Annual Deposit Agreement’, and each Cash distribution cannot exceed |
| | the ‘Cash distribution’ fee. |
| | DSF9.7 Net DSF from Cash Div’ equals N, ‘Annual DSF and Cash Div Fee Cap’is blank, and |
| | ‘Annual Cash Div Fee Cap’is entered: |
| | Total Cash distribution fees for a year cannot exceed ‘Annual Cash Div Fee Cap’. The DSF fee in a |
| | year cannot exceed ‘Annual Deposit Agreement and each Cash distribution cannot exceed the ‘Cash |
| | distribution’ fee. |
| | DSF9.8 Net DSF from Cash Div’ equals Y, ‘Annual DSF and Cash Div Fee Cap’is blank, and |
| | ‘Annual Cash Div Fee Cap’is entered: |
| | Total Dividend Fees for a year cannot exceed the ‘Annual Cash Div Fee Cap’, and each Cash |
| | distribution cannot exceed the ‘Cash distribution’ fee. DSF must be subtracted from the Cash |
| | distribution fee(s) for the year. |
| DSF10.0 | Enhance and move PowerBuilder Dividend application DSF Event to the Corporate Action |
| | Dividend DSF Web application. Migration of historical Event data. For the 2008 and prior year |
| | DSF Events that did NOT have an accrual the System will create a “line item” on the last month of |
| | the service period showing one months accrual and the remainder for the service period as the |
| | accrual adjustment and the cash received and total income “buckets” will be populated. For those |
| | with an accrual the date will be migrated to match with the accruals that already been migrated. All |
| | of the 2009 DSF events a and 2010 events will NOT need to be migrated as the data is currently |
| | planned to load prior to phase II. |
| DSF11.0 | Create announcement letter for the DSF utilizing the Corporate Action phase II technology for the |
| | creation and e-mail the announcements to the Security Depositories and the DR Administration |
| | Group. The DSF announcements should be sent out at the time of creation, similar to the Dividend |
| | announcements. |
| | Note: A DSF Event Announcement is being generated by the PowerBuilder DR-Ops DSF |
| | component (DR-Ops->Dividends->Reports->DSF Notice), however; the DSF Processor does NOT |
| | utilize it, as the announcements are a one CUSIP to one announcement relationship. |
| | The Announcement is to be created and sent even if the current position is (0). The position may |
| | change by the Record Date. |
| | For a standalone DSF the announcement will be sent out 30 calendar days before the Record date. |
| DSF12.0 | Build an e-mail DSF alert process for Shareowner Services’ so that; they can notify and bill the |
| | registered shareholders (E-mail of daily and/or monthly Event R/Ds).This process is currently under |
| | development with SoS. The e-mail will include CUSIP, DSF Rate and Record Date for each of the |
| | DSF Events. In addition, if there are negotiated holders then the account holders information must |
| | be provided to the SoS Group, so that they can have the standard invoice pulled and destroyed. If |
| | payment is due a manual invoice will need to be sent to these holders. |
| DSF13.0 | Move the DSF Posting functionality from Dividend Workstation to the web. |
| | Note: DSF posting functionality allows the user to search by CUSIP or company name, and |
| | returns summary information for issue plus list of dividends paid for that issue. |
| | Allow the DR staff to input/update the DTC/Common Depositories (EuroClear, ClearStream) and |
| | total Registered holder Share balance positions into the CA DSF application along with a comments |
| | section. There must be an approval process for the updating of share balances to the system. This |
| | information will be stored and a reconciliation process will be built to ensure that the DSF is |
| | assessed according to the DA. A Share “out of Balance” report will be created and systemically |
| | produced daily. The report will have the Total “custodian share as of the record date; the individual |
| | shares amount input &approved; the difference between the total and the input number and any |
| | comments. The Share amount entered in the share section will determine the Funds that are |
| | anticipated form each of the entities. This information must feed into the payment section in order |
| | for the application to track funds anticipated to the actual funds received. |
| | Allow the DR staff to input/update the DSF Actual payment data once payments are received and |
| | tied them to a particular DSF Event along with a comments section. There MUST be an approval |
| | process for the updating of cash to the system. This data will be stored and a reconciliation process |
| | will be built to ensure that the DSF is assessed according to the DA. A Fund “out of Balance” report |
| | will be created and systemically produced daily. The report will have the Total Funds anticipated |
| | from each group and the individual amounts input &approved; the difference between the total and |
| | the input number and any comments recorded. |
| | A Claims process for both the Shares and Funds will need to be created, which allows for the |
| | creation, storage and sending of e-mails to individual outside entities. |
| DSF14.0 | Systemically evaluate if an Issuer/Program has an upcoming Cash distribution or Right distribution |
| | and an outstanding DSF fee Event. |
| | DSF14.1 If the MasterFile DSF in Deposit Agreement Field =>0 and the CA DSF Charge DSF |
| | Field = (Y) do a System evaluation to determine if a DSF Event has been assessed for the prior and |
| | current year. If a DSF has been assessed for both years, No Action taken. IF DSF has not been |
| | assessed see rule DSF14.2 |
| | DSF14.2 If the MasterFile DSF in Deposit Agreement Fee is >0 and DSF application Charge DSF |
| | Field = Y then evaluate on daily basis if a Dividend or Rights Event is created in Corporate Action; |
| | if an event is created notify the Dividend processor and Approver of the outstanding DSF fee, so |
| | that they will be able to assess the DSF in the Service fee section on the Dividend input panel. |
| | B14.3 If a DSF is assessed with the Dividend we will need to store the “DSF Event” utilizing the |
| | same Record date as the Record Date from the Dividend and utilize the information from DR-OPs |
| | Note: Do Not create or send out a DSF announcement |
| | Note: The earliest year is always the first to have the DSF Fee applied. |
| | A warning message must be sent to the Operations Group, when the Accruals and Event are in the |
| | same year and the netting from a cash distribution is (Y) or the Cash/DSF either/or = Y. In these |
| | scenarios, the application will try and tie the DSF to be accessed with the Dividend but, if a |
| | dividend fee is assessed that will change the DSF total fee available and in most case reduce it to |
| | zero. The operator will need to know that they must either reduce the DSF to be assessed or possible |
| | not assess a DSF at all. |
| DSF15.0 | Systemically link the DSF Fee payment received via the Dividend process to the System generate |
| | DSF Event outline in DSF14.3 The DSF funds will be credited to a Payable account by the |
| | Dividend processor. A System generated ticket will be produced to Debit the payable account and |
| | credit the Billed receivable account on the DSF application. |
| DSF16.0 | Linking the yearly DSF Accrual Process with the DSF Actual Event. |
| DSF17.0 | Create financial transaction tickets that will be input into the Banks Financial System for the DSF |
| | Actual payments that are data entered into the new Web application. This will entail creating tickets |
| | to reverse/modify the Accruals (if any) |
| | Proposed Restrictions for payment input: 4:00 PM cutoff for input of payments received and |
| | approval; Prior day's payments must be marked as processed before the next business day's |
| | payment input may proceed. In the event of user's failure to mark prior day's input, only payment |
| | input will be prevented. All other functionality will be permitted. |
| DSF18.0 | Enhance and move the PowerBuilder Dividend applications DSF Approval process to the Corporate |
| | Action Dividend DSF Web application. Each DSF process will require their own approval. Event, |
| | RD shares positions and payments received. |
| DSF19.0 | Enhance the current MasterFile DSF Forecast Report |
| | DSF19.1 = Enhance the DSF Forecast Report utilizing the DSF Fields in MasterFile and the CA |
| | Dividend DSF application. The CA Dividend DSF data will be utilized in addition to the MasterFile |
| | and DR-Ops data to compile the report. |
| | Change due to MasterFile solutions outlined in DSF.1 |
| | DSF19.1.1 Add to the DSF Forecasting Report, ‘DSF and Cash Div Fee Annual Cap’ and ‘Annual |
| | Cash Div Fee Cap’ following ‘Net DSF from Cash Div’. All other data in the report should be |
| | accurately reflected, including Prior Year Div Fee Collected. |
| | Enhance the current PowerBuilder DR-Ops PSR Report Dividend_vs_DSF Fee Report.psr |
| | DSF19.2 = Enhance the Dividend_vs_DSF Fee Report utilizing the DSF Fields in MasterFile and |
| | the CA Dividend DSF application. The CA Dividend DSF data will be utilized in addition to the |
| | MasterFile and DR-Ops data to compile the report. |
| | Create and enhance DSF reports to accommodate the Financial, Reconciliation and Client reporting |
| | of the DSF |
| DSF20.0 | Build into the Corporate Action Dividend Application the Flexibility to Stop/Cancel-Back- |
| | out/Cancel - Process with a Dividend/Cancel and Re-set the DSF Events within a 48 hour or two |
| | day threshold. Modifications to the DSF data on the DSF panel for a DR Program will allow the |
| | RM/RH to modify the DSF Event criteria as stated above, If an announcement has already been sent |
| | then a rescind announcement will need to be generated. |
| DSF21.0 | Systematically utilize SWIFT messages that are coming in to the Bank for DSF Event payment to |
| | update the new Corporate Action Dividend DSF Web application and the Banks Financial Systems. |
| DSF22.0 | Update DR Website with DSF Fee Announcement information for each of the DR programs |
| | assessed. The information should be posted for 90 days from the day it is announced to the |
| | “Street”/Event announcement e-mail date. |
| DSF23.0 | Create Automated Claim process, which will include creating and storing PDF of Claim letters and |
| | tracking Claims. The Claims can be for any Share position break and/or a DSF over/under payment. |
| DSF24.0 | Create a Tickler that will be sent to the RMs and RHs each year (at budget time); which will prompt |
| | them to Re-certify/Forecast the DSF for the upcoming year. This Tickler should be sent until all |
| | Programs have a determination and will be escalated to the RH/D after 30 days. |
| DSF25.0 | When a DSF is assessed with a Dividend a warning message to alert Dividend processors that the |
| | Fee (s) being assessed if greater then 12% of the total allocation needs to be displayed on DR-Ops. |
| | “The threshold of 12% fee has been reached; please contact the RM for approval before processing. |
| DSF26.0 | Create an alert (Tickler) process to notify the RM and RH if their forecast DSF is modified during |
| | the year. (Net with Cash distribution and Cash or DSF will change the DSF anticipated). |
| DSF27.0 | Track and accommodate for Programs Life cycles (OTC to Level II/III, Name change, CUSIP |
| | changes Switch in Depositaries, Unsponsored to sponsored) |
| | DSF27.1 Change in DR Program (PPC, delisting, Level I to Level II/III, Unsponsored to |
| | Sponsored) If there is a New Deposit Agreement that is in effect as a result in a change in the |
| | Program, then the RM/D will need to complete the Forecast process for the new program and have it |
| | approved by the RH/D as a result the existing program's accrual will be reversed for the current |
| | service period and written. In addition, the DSF Event for the prior service period (if one exists) will |
| | need to be accelerated to a date prior to the termination date so that the DSF can be collect. If the |
| | RM/D and/or RH/D Determine that the prior year's DSF should NOT be collected then they will |
| | need to cancel the Event via the DSF Event cancel process and the prior years Accrual will need to |
| | be written-off. If there is a change in the program and the CUSIP remains the same and the program |
| | is not terminated then the RM should have the option keep the DSF Accruals and Event intact. |
| | DSF27.2 Name change - should only reflect the name change |
| | DSF27.3 CUSIP change - Link the “old and “new” CUSIPs to reflect the proper Accrual |
| | Accounting for the Programs Service period. Utilize “old” CUSIP Div Fee for netting purposes. If |
| | the CUSIP change is do to a change in the DR program (i.e. a change in the DA) then follow the |
| | outline in DSF27.1. |
| | DSF27.4 CUSIP change/Ratio change Link the “old and “new” CUSIPs to reflect the proper |
| | Accrual Accounting for the Programs Service period. Utilize “old” CUSIP Div Fee for netting |
| | purposes. If the CUSIP change is do to a change in the DR program (i.e. a change in the DA) then |
| | follow the outline in DSF27.1. |
| | DSF27.5 Termination of the DR program (Lost to competitor, Issuer request) The Accrual |
| | Accounting will be reversed for the current service period and written-off. In addition, the DSF |
| | Event for the prior service period (if one exists) will need to be accelerated to a date prior to the |
| | termination date so that the DSF can be collect. If the RM/D and/or RH/D determine that the prior |
| | years DSF should NOT be collected, then they will need to cancel the Event via the DSF Event |
| | cancel process and the prior years Accrual will need to be written-off. |
| DSF28.0 | Track and accommodate for CA Events (stock splits, Spin-offs, mergers) for both the DSF Accrual |
| | accounting and the DSF Events |
| | DSF28.1 Stock Splits and Ratio changes - No special process/handling is required for the Accrual |
| | accounting. There will be special handling/processing required at the time of the DSF Event to |
| | ensure that the DR Division is compensated correctly for the Depositary Services provided over the |
| | service period. |
| | DSF28.2 Spin-offs - No special process/handling is required for the Accrual accounting on the |
| | existing Program. If there is a New Program that is in effect as a result of the spin-off, the New |
| | Program's RM/D will need to complete the Forecast process and have it approved by the RH/D. |
| | There may be special handling/processing required at the time of the DSF Event to ensure that the |
| | DR Division is compensated correctly for the Depositary Services provided over the service period. |
| | DSF28.3 Mergers/Acquisitions - If there is a Change in the Program which results in a change in the |
| | DA then use the outline in DSF27.1. If the RM, RH or GCAT managers want to handle the DSF |
| | differently they will need to take it offline, as these (Mergers/Acquisitions) are managed Events and |
| | the RM, RH and GCAT managers should be aware of the impact on the DSF. |
| DSF29.0 | At the time of the RM/RH Budget Forecasting or at any time on an ongoing basis during the accrual |
| | service period the RM/RH should have the ability to split a quantity of shares from the primary |
| | accrual line to account for any negotiated terms affecting assessable fees, into one or more accrual |
| | line wherein the shares to be considered in the accrual will be subjected to rates other then the |
| | standard accrual rate not to exceed that rate and could include a zero rate. Each quarter a tickler will |
| | be sent to the RM requesting that they perform a positive confirm on the share positions for the |
| | Negotiated Fee holders. The CA DSF application will track the confirmations and send follow-up |
| | ticklers to the RM and RH for DR program that are not confirmed. |
| DSF30.0 | Through-out this DSFD we reference the RM/D and/or RH/D as the person(s) with the ability to |
| | update and approved the Forecasting process. For the Unsponsored DR Programs the Unsponsored |
| | Administrator/Designee and the GCAT Manager/Designee will fulfill those roles |
| DSF31.0 | Prior to running the Monthly DSF Accrual process a “preliminary” process will need to be run and a |
| | Tickler Report generated to ensure that the changes that will be reflected in the monthly process is |
| | true and correct. This Tickler report will need to broken down by Region and sent to the Regional |
| | Heads (Sponsored Programs) and the GCAT manager (Unsponsored Programs). |
| | The criteria for the Tickler Report will be any changes to the DSF in the Amount greater then |
| | (25,000.00). |
| DSF32.0 | Corporate Actions Dividend application systematically needs to be notified if |
| | DSF32.1 Annual Depositary Service - Issuer Negotiated Fee' changes |
| | DSF32.2. Annual Depositary Service - Deposit Agreement' changes |
| | DSF32.3 Net DSF from Cash distribution changes |
| | DSF32.4 Cash distribution event occurs |
| | DSF32.5 DSF event occurs |
| | DSF32.6 DR Terminates |
| | DSF32.6.1 DR goes Effective |
| | DSF32.7 Cash distribution is deleted |
| | DSF32.8 Deposit Agreement Limit changes |
| | DSF32.9 Annual DSF & Cash Div Fee Cap changes |
| | DSF32.9.1 Annual DSF & Cash Div Fee Cap Amount' changes |
| | DSF32.10 The fields DSF in Deposit Agreement, Charge DSF and Net DSF from Cash distribution |
| | as well as the Fee fields on the DR Documentation profile should now be approved together. |
| | DSF32.11 ‘Negotiated Fee Shareholders’ changes |
| | DSF32.12 ‘DSF Revenue Sharing’ changes |
| | DSF32.13 ‘DSF Revenue Sharing Issuer Percent’ changes |
| DSF33.0 | PIM report should be updated to use the new accrual structure |
| DSF34.0 | Profitability Report should be updated to use the new accrual structure |
| DSF35.0 | Revenue Report should be updated to use the new accrual structure |
| DSF36.0 | Migrate DSF Accrual information for 2009 and prior years from the DR Ops PowerBuilder |
| | application to the new CA DSF application |
| DSF37.0 | Migrate the DSF Event information for 2009 and prior years from the DR Ops PowerBuilder |
| | application to the new CA DSF application. |
| DSF38.0 | For all Charge DSF (N) within a service period track and send an E-mail message to the RM that a |
| | Issuer normal Dividend schedule has past and the Issuer has not declared a Dividend. This will |
| | allow the RM to re-evaluate charging a DSF. |
| DSF39.0 | RH & RM e-mail alert for a standalone DSF having a record dates that is 60 calendar days from the |
| | current date. This is an alert notifying the RH & RM that a DSF will be assessed on the record date |
| | for the Issuer. This same alert must go out when the DSF is being assessed with a Dividend. |
| DSF40.0 | A communication (e-Mail) process needs to be set-up with the Common Depositories and |
| | Shareowner Service group requesting the R/D balance for the DSF Issues. This may tie into the |
| | common DEPO recon project. |
| DSF41.0 | Create DSF Reconciliation Report to be utilized by the Reconciliation Group and Management. The |
| | report will show the Record Date Custodian Position + any pending transaction; the DTC position, |
| | Common Depositories and Registered holder positions and the difference (if any). Example: R/B +/− |
| | pending = DTC, + Com. Depo. + Reg. Holder (excluding DTC and Common Depositaries) |
| DSF42.0 | The CA DSF Application should NOT allow the set-up of a DSF Event and DSF Accrual in the |
| | same year for Programs that have netting language in the Deposit Agreement and a Cash Event that |
| | had a Cash Fee that exceeded the DSF Fee. |

Table III provides a listing of exemplary actions for Cash Distribution/Dividends (“CDD”) processing in the CA platform, identified as numbered “CDD requirements” or “objectives” (“CDD”).

TABLE III
Corporate Action Cash Distribution/Dividends Functionality

| Objective | Processing Description |
|---|---|
| CDD1.0 | Modify and/or add fields in MasterFile and Design Fields and/or calculate and display values in CA |
| | Cash Dividend/Distribution application from the historical and current data in order to facilitate the |
| | Sub-ledger Accounting and Cash Dividend/Distribution DR Event Process. |
| | CDD1.1 Modify MasterFile to include the maximum Fee for Cash D/D as outlined in the Deposit |
| | agreement and Letter agreement (Event and per annum). MasterFile solution - change existing |
| | MasterFile Cash Dividend field to “Cash Dividend Event” Fee. |
| | CDD1.1.1 Modify MasterFile to include the maximum Cash distribution Fee as outlined in the |
| | Deposit agreement and Letter agreement (Event and per annum). MasterFile solution - add field in |
| | MasterFile (Annual Cash Div Fee Cap) |
| | CDD1.1.2 Add field(s) to MasterFile in order to accommodate a maximum Cash distribution fee and |
| | a maximum Cash/DSF combination as outlined in the Deposit agreement and Letter agreement (per |
| | annum). MasterFile solution - add field in MasterFile (Annual DSF & Cash Div Fee Cap) |
| | CDD1.1.3 Cash D/D Revenue Sharing (Y/N) If yes, percentage. |
| | CDD1.1.4 Negotiated Fee holders (Y/N) If yes, number of shares held by Negotiated Fee holder(s) |
| | (value) Cash D/D Fee to apply to Negotiated Fee holders (Value). The Negotiated Fee rate will need |
| | to be applied in each Cash D/D Event. (Treasury Shares) |
| | CDD1.1.5 A warning message needs to be given to the Dividend/Distribution processor at the time of |
| | a DR Event being created on the CA application. If a conflict on Dividend fee and DSF fee exist |
| | when there is an annual Cap on Cash and DSF Fee. The Processor should NOT be able to override |
| | the MasterFile DA fee limits that results in a greater fee then what is allowed in the DA. |
| | Note: Cash D/D display values will be updated with the most current data available in MasterFile, |
| | CA and DR-Ops. A Cash distribution, Stock, Rights, and Cash distribution, DSF Event which is |
| | Approximate and/or Final approved will affect the values. |
| CDD2.0 | Create a CA Dividend/Distribution Web Screen which will pull data from MasterFile, DR-Ops and |
| | Corporate Actions that the Relationship Manager (RM) or Designee (D) can view and input into, so |
| | that; the required Cash D/D values can be updated when a new Issuer/program is established or at the |
| | time of RM is budget forecasting for the year. |
| | The screen should allow the RM/D to set-the Cash D/D rules which will determine the Cash D/D to |
| | be assessed and will be “Driver” for the Cash D/D Sub-Ledger Accounting and Cash D/D Event |
| | process. |
| | In addition, it should allow the RM/D to make a decision on assessing Cash D/D Fee prior to the |
| | Cash D/D Event and allow manual overrides to cancel and reinstitute Cash D/D Fees for the events |
| | Warning messages and Security locks (RACF) are required on the screen, so that; only authorized |
| | personnel can input or make changes. |
| | The Screen should allow the RM/D to view and update the prior and current year parameters and |
| | input forecast data for the upcoming year; which will be updated with the Actual fees information as |
| | Events are processed on CA application. |
| | The Screen should also allow the user to navigate by a click of her/his mouse between the DR |
| | Approval Queue, Corporate Actions, MasterFile, Billing, IMMR and Reconciliation Web |
| | applications and the screens and reports of the Corporate Actions application. |
| CDD3.0 | Create an approval process for the Regional Head (RH) or Designee (D) to approve the RM/D input |
| | to the required Cash D/D Web screen when a new Issuer/program is established and/or if the RM/D |
| | updates the required Cash D/D information. |
| | An RH/D can override whether a Cash D/D fee will be assessed; by rejecting the information the |
| | RM/D(s) inputted into the required Cash D/D process screen. A reject message (e-mail) should be |
| | sent to the RM/D stating the Cash D/D information has been reject and requires updates. A comments |
| | field is required so that the RH/D can comment on what needs to be adjusted by the RM/D and/or |
| | which fields require his/her attention. The RH/D should be able to mark a reject, make a comment on |
| | that reject and approve the remainder of the Cash D/D fee to be assessed. |
| | Warning messages and Security locks (RACF) are required on the process/screen, so that; only |
| | authorized personnel can make changes. |
| | The Screen should allow the RH/D to view the prior and current year statistics and input forecast data |
| | for the upcoming year; which will be displayed with the Actual fees information as Events are |
| | processed on CA application. |
| | The Screen should also allow the user to navigate by a click of her/his mouse between all of the DR |
| | Web applications as outlined in CDD2.0 and the screens and reports of the CA application. |
| CDD4.0 | Develop rules for the Cash D/D fees; both for new clients and existing clients utilizing the current |
| | Cash D/D fields in MasterFile the values from the CA application and the calculated values in the CA |
| | application. |
| | CDD4.1: If the MasterFile “Cash D/D Event fee'” = (blank or 0) then no fee will be assessed; |
| | CDD4.2: If the MasterFile “Cash D/D Event fee' = (>0) and MasterFile Issuer Negotiated Cash |
| | D/D Fee = (blank or 0) then no fee will be assessed; |
| | CDD4.3 If the MasterFile “Cash D/D Event fee' = (>0) and MasterFile Issuer Negotiated Cash D/D |
| | Fee = (>0) Then a fee will assessed according to the CA Cash D/D Fee table; |
| | CDD4.4 If the MasterFile “Cash D/D Event fee' = (>0) and MasterFile Issuer Negotiated Cash D/D |
| | fee = (>0) Then a fee will assessed according to the CA Fee table unless; |
| | CDD4.4.1 The Cash D/D annual Fee cap has been reached or; |
| | CDD4.4.1 The Cash D/D and DSF annual fee cap has been reached. |
| | Rule-Blank and No equal the same |
| CDD5.0 | Create structure to store the Sub-ledger accounting in Corporate Action application Cash D/D |
| | component. Tracking of the Receivables, Payables (Issuer, BNYMellon), Incomes (Issuer, |
| | BNYMellon), Collected, Fees and Total Funds outstanding for each Program and CUSIP. |
| | Authorized personnel should be able to view this data and run reports by Region, Program, CUSIP, |
| | Record Date, Payment Date, Payment Received/Made Date, Dollar amount and by each of the |
| | tracked values. |
| CDD6.0 | Create financial transaction tickets that will be input into the Financial System for the Cash D/D |
| | Event. |
| | CDD 6.1 This will entail creating an Input panel that will allow the Users to input the financial |
| | entries to the CA application. The User's must have the ability to chose what DR program, CUSIP, |
| | Record Date and DR Event they want to apply the financial entries to. |
| | CDD 6.2 Create an approval process that will allow the Approvers to approve the financial entries on |
| | the CA application. The Approvers must have the ability to choose what DR program, CUSIP, |
| | Record Date, DR Event and Financial transactions they want to approve. |
| | A User and Approver will have different Security access to the payment panels. An approver can Not |
| | approve their own changes. |
| CDD7.0 | Create a report of the Financial entries (detail and totals), the adjustments to them (details and totals) |
| | and the Actual Cash D/D Funds required. The report may be produced ad-hoc. |
| | Authorized personnel should be able to view this data and run reports by Cash D/D Event, Program, |
| | CUSIP, DR Name, DR Status, Country of Management, Region, Relationship Manager New York, |
| | Relationship Manager, Unsponsored Administrator and should be able to be sorted by each of the |
| | tracked values. The Primary, Interim, and Restricted, as well Bifurcated CUSIPs should be displayed |
| | on the reports with their related programs. |
| | The Financial Transaction Report should include the Detail and Totals of the Financial that are posted |
| | on the Financial Transaction tickets. |
| | The Report should also available in an Excel and PDF format. |
| CDD8.0 | Enhance and move PowerBuilder Dividend application Cash D/Ds Event to the Corporate Action |
| | Web application. |
| | CDD 8.1 Link back to the historical Event data for the 2011 and prior year Cash D/D Events that did a |
| | Cash Event with views to Inquiry, spreadsheet entry and totals received tabs. |
| CDD9.0 | Create a Cash D/D Input screen/panel that will be populated with the Underlying Event data when the |
| | User(s) create a DR Event from the Underlying Event. |
| | CDD.9.1 The screen/panel needs to allow for updates and modification, which will include the ability |
| | to unapproved and modify the data in different stages of the Cash D/D process including Final |
| | approved. |
| | CDD.9.2 For Bifurcated Programs the CA application should systemically create/modify the Cash |
| | D/D for the Reg S. Program once the 144A program information is approved. |
| | CDD.9.3 Combine dividend events into one if there is more than one CUSIP backed by the same |
| | underlying ISIN and the DR to Ordinaries ratio is the same. |
| | The current PowerBuilder Screens allow the users to input, approve, Update, approve and delete Cash |
| | Dividend/Disbursements. |
| CDD.10 | Create an approval process for the Input screen/panel which will be required whenever the data is |
| | modified on the Input screen/panel. |
| | Only persons with approval right will be able to approve a transaction. Rule: No one person can |
| | input and approve a transaction on this screen/panel. |
| CDD11.0 | Add a link to MasterFile to facilitate the closing of the books for Cash Dividends/Distribution. |
| | CDD.11.1 Add a Terminated indicator even though there are shares still outstanding - Often times |
| | DR announce dividends on terminated issues. The system should alert the Users that the issue is |
| | terminated. |
| CDD12.0 | Add Tables to include Country Base rules (ex: Record dates, Payable dates, FX, NOSTRO, |
| | Reconciliation) |
| CDD12.0 | Move the Cash D/D Spreadsheet entry functionality from Dividend Workstation to the CA web |
| | application. |
| | Note: The Cash D/D spreadsheet posting functionality needs to allow the user to search by |
| | CUSIP or company name, and returns summary information for DR issue plus list of DR |
| | Events for that issue. |
| | Allow the DR staff to input/update the DTC/Common Depositories, Custodian and total Registered |
| | holder share balance positions into the CA application along with a comments section. There MUST |
| | be an approval process for the updating of share balances to the system. This information will be |
| | stored and the Record Date Proof (RDP) process will be utilized to ensure that the Cash D/D is |
| | process according to the DA. |
| | A Share “out of Balance” report will be created and systemically produced daily. The report will have |
| | the Total “custodian share as of the record date; the individual shares amount input &approved; the |
| | difference between the total and the input number and any comments. The Share amount entered in |
| | the share section will determine the Funds that are anticipated form each of the entities. This |
| | information must feed into the payment section in order for the application to track funds anticipated |
| | to the actual funds received & paid out. |
| | Allow the DR staff to input/update the Cash D/D Actual payment data once payments are received |
| | and tied them to a particular Cash D/D Event along with a comments section. There MUST be an |
| | approval process for the updating of cash to the system. This data will be stored and a reconciliation |
| | process will be built to ensure that the Cash D/D is assessed according to the DA. A Fund “out of |
| | Balance” report will be created and systemically produced daily. The report will have the Total Funds |
| | anticipated from each group and the individual amounts input &approved; the difference between the |
| | total and the input number and any comments recorded. |
| | A Claims process for both the Shares and Funds will need to be created, which allows for the |
| | creation, storage and sending of Claim e-mails to individual outside entities. |
| CDD14.0 | Systemically create the Cash D/D Fed-wire payment (credit to Fed-wire account) via the Dividend |
| | process to the SOS group (debit to a Payable account) via a processing ticket. A System generated |
| | ticket will be produced to debit the payable account and credit the Fed-Wire account on the Cash D/D |
| | U.S. payment date via the CA application. |
| CDD15.0 | Systemically create the Cash D/D Fee received (credit Income) via the Dividend process to the |
| | System generate (debit to a Payable account) via a processing ticket. A System generated ticket will |
| | be produced to debit the payable account and credit the Income account on the Cash D/D U.S. |
| | payment date via the CA application. |
| CDD16.0 | Create financial transaction tickets that will be input into the Banks Financial System for the Actual |
| | payments that are data entered into the new Web application. This will entail creating tickets to |
| | reverse/modify the Financial Accounts due to reversal/corrections (if any). |
| | Proposed Restrictions for payment input: |
| | 4:00 PM cutoff for input of payments received and approval, |
| | Prior day's payments must be marked as processed before the next business day's payment input may |
| | proceed |
| | In the event of user's failure to mark prior day's input, only payment input will be prevented. All |
| | other functionality will be permitted |
| CDD17.0 | Link all of the sub-ledger Financial transactions input in the payment process screen/panel for a Cash |
| | D/D to the Actual DR Event(s) that they were processed against. |
| CDD18.0 | Enhance and move the PowerBuilder Dividend applications Cash D/D Approval process to the |
| | Corporate Action Web application. Each Cash D/D process will require their own approval, Event, |
| | RD shares positions and payments. |
| CDD19.0 | Enhance the current DR-Ops Cash D/D Reports to allow for Forecasting of the Fee to be assessed |
| | CDD19.1 = Create a Cash D/D Forecast Report utilizing the Cash D/D Fields in MasterFile and the |
| | CA application. The CA Cash D/D data will be utilized in addition to the MasterFile data to compile |
| | the report. Change due to MasterFile solutions outlined in CDD.1 |
| CDD20.0 | Build into the Corporate Action Dividend Application the Flexibility to Stop/Cancel-Back- |
| | out/Cancel - Process without fee/Cancel and Re-set the Cash D/D Events. Modifications to the Cash |
| | D/D data on the CA panel for a DR Program will allow the Users to modify the Event criteria as |
| | stated above, If a notification has already been sent then a rescind/change notification will need to be |
| | generated. |
| CDD21.0 | Modify/Update CA application and any other systems and/or data-feeds that are currently used to |
| | update or extract data from the dividend application in order to accommodate the “new” Corporate |
| | Action Cash D/D process |
| | CDD.21.1 Modify the QAWO feed to Shareowner Services |
| CDD22.0 | Update DR Website with Cash D/D Announcement for each of the DR programs processed. The |
| | information should be posted for 365 days from the day it is announced to the “Street”/DR Event |
| | announcement e-mail date. (Mike S. to send Maria L and team outline of information required on the |
| | Website and Announcement Templates.) |
| CDD23.0 | Create Automated Claim process, which will include creating and storing PDF of Claim letters and |
| | tracking Claims. The Claims can be for any Pre-Release position break, Out of proof position break |
| | and/or any over/under payment. |
| CDD24.0 | Create a Tickler that will be sent to the RMs and RHs each year (at budget time); which will prompt |
| | them to Re-certify/Forecast the Cash D/D for the upcoming year. This Tickler should be sent until all |
| | Programs have a determination, and will be escalated to the RH/D after 30 days. |
| CDD25.0 | When a Cash D/D Fee is assessed a warning message to alert Dividend processors that the Fee (s) |
| | being assessed if greater then 12% of the total allocation needs to be displayed on CA. “The threshold |
| | of 12% fee has been reached; please contact the RM for approval before processing. |
| CDD26.0 | Create an alert (Tickler) process to notify the RM and RH if their forecast Cash D/D is modified |
| | during the year. |
| CDD27.0 | Track and accommodate for Programs Life cycles (OTC to Level II/III, Name change, CUSIP |
| | changes Switch in Depositaries, Unsponsored to sponsored) |
| | CDD27.1 Change in DR Program (PPC, delisting, Level I to Level II/III, Unsponsored to Sponsored) |
| | If there is a New Deposit Agreement that is in effect as a result in a change in the Program, then the |
| | RM/D will need to complete the New Fee process for the new program and have it approved by the |
| | RH/D. |
| | CDD27.2 Name change - should only reflect the name change |
| | CDD27.3 CUSIP change - Link the “old and “new” CUSIPs to reflect the proper Financial |
| | Accounting for the Program. Utilize “old” CUSIP Div Fee for netting/maximum allowed purposes. If |
| | the CUSIP change is do to a change in the DR program (i.e. a change in the DA) then follow the |
| | outline in CDD27.1. |
| | CDD27.4 CUSIP change/Ratio change Link the “old and “new” CUSIPs to reflect the proper |
| | Accounting for the Programs Service period. Utilize “old” CUSIP Div Fee for netting purposes. If the |
| | CUSIP change is do to a change in the DR program (i.e. a change in the DA) then follow the outline |
| | in CDD27.1. |
| | CDD27.5 Termination of the DR program (Lost to competitor, Issuer request) The Accounting will |
| | be modified. In addition, the Cash D/D Event for the period will need to be accelerated to a date prior |
| | to the termination/initial sales date so that the Cash D/D can be processed. If the RM/D and/or RH/D |
| | determine that the Cash D/D should NOT be processed, then they will need to communicate to the |
| | cancel of the Cash D/D Event cancel process. |
| CDD28.0 | Track and accommodate for CA Events (stock splits, Spin-offs, mergers) for both the Cash D/D |
| | Financial accounting and the Cash D/D Events |
| | CDD28.1 Stock Splits and Ratio changes - Special process/handling is required for the Financial |
| | accounting. There will be special handling/processing required at the time of the Cash D/D Event to |
| | ensure that the DR Division is compensated correctly for the Dividend/Distribution Fee provided that |
| | the SS or RC is between the RD and PD period. |
| | CDD28.2 Spin-offs - Special process/handling is required for the Financial accounting. There will be |
| | special handling/processing required at the time of the Cash D/D Event to ensure that the DR |
| | Division is compensated correctly for the Dividend/Distribution Fee provided that the SS or RC is |
| | between the RD and PD period. The process will have to be approved. |
| | There may be special handling/processing required at the time of the Cash D/D Event to ensure that |
| | the DR Division is compensated correctly over the RD & PD period. |
| | CDD28.3 Mergers/Acquisitions - If there is a Change in the Program which results in a change in the |
| | DA then use the outline in CDD27.1. If the RM, RH or GCAT managers want to handle the Cash |
| | D/D differently they will need to take it offline, as these (Mergers/Acquisitions) are managed Events |
| | and the RM, RH and GCAT managers should be aware of the impact on the Cash D/D. |
| CDD29.0 | Through-out this CDDD we reference the RM/D and/or RH/D as the person(s) with the ability to |
| | update and approved the Forecasting process. For the Unsponsored DR Programs the Unsponsored |
| | Administrator/Designee and the GCAT Manager/Designee will fulfill those roles |
| CDD30.0 | Redesign the current Cash Dividend Output and Reports from PowerBuilder application and |
| | incorporate it into the Corporate Action Web application. |
| | CDD.30.1 Redesign the current Cash Dividend Approval functionality from PowerBuilder |
| | application and incorporate it into the Corporate Action Web application. |
| | CDD.30.2 Redesign the current Cash Dividend Administration functionality from PowerBuilder |
| | application and incorporate it into the Corporate Action Web application |
| CDD31.0 | Enhance the Dividend Administration functionality in order to eliminate manual tasks/processes. |
| | MasterFile and/or Corporate Actions should update available data whenever/wherever possible, in |
| | order to eliminate having to update (data enter) the same information into the Dividend |
| | Administration Workplace. |
| CDD32.0 | Corporate Actions Dividend application systematically needs to be notified if any of the MasterFile |
| | fields change that will have an impact on the Cash Dividend/Distribution Process |
| CDD33.0 | PIM process should be updated to use the new Cash D/D structure |
| CDD34.0 | Profitability Report should be updated to use the new Cash D/D structure |
| CDD35.0 | Revenue Report should be updated to use the new Cash D/D structure |
| CDD36.0 | There will be no Migration of the Cash D/D information for 2010 and prior years from the DR Ops |
| | PowerBuilder application to the new CA Cash D/D application; user will be able to access the |
| | information via a link to the PowerBuilder Application tables. |
| CDD37.0 | Modify/Update DR MasterFile and any other systems and/or data-feeds that are currently used to |
| | update or extract data from the dividend application in order to accommodate the “new” Corporate |
| | Action Dividend web application |
| | QAWO feed to Shareowner Services |
| | e-GOVdirect feed to the NYSE |
| | Broker Report under operational reports feed to the ADR Website |
| | Access and/or update the historical dividend data that is in DR-Ops from the Corporate Action |
| | Dividend Web Application |
| CDD38.0 | Within the YTD period track and send an E-mail message to the RM that an Issuer's normal |
| | Dividend schedule has past and the Issuer has not declared a Dividend. This will allow the RM to re- |
| | evaluate charging a DSF to RIF's fee. |
| CDD39.0 | Create Cash D/D Reconciliation Report to be utilized by the Reconciliation Group and Management. |
| CDD40.0 | Build a Fee calendar for the Cash D/D that have monthly disbursements and the RM/RH only want to |
| | assess a fee in certain months. |
| CDD41.0 | Add Field to rate input screen/panel to allow for the Tax Reclaim fee to be part of the calculations |
| | and announcement. This will include being part of the defaulted fields according to the Country Rule |
| | supplied by Operations group. |

Table IV provides a listing of exemplary actions for Security Sales Project processing in the CA platform, identified as numbered “sales requirements” or “objectives” (“S”).

TABLE IV
Corporate Action Security Sales Functionality

| Objective | Processing Description | | |
|---|---|---|---|
| S1.0 | Underlying Event | | |
| | System needs to be able to facilitate multiple ISINs (entitlements). The system needs the ability to | | |
| | handle storing both Entitlement ISIN and Entitlement Rate. | | |
| S2.0 | Reconciliation Application (In Process) | | |
| | S2.1 Users need the ability to notify the Reconciliation Team when to begin reconciling. Once | | |
| | reconciliation is complete, GCAT needs the ability to request additional reconciliations based on | | |
| | other dates. Note: situations may arise when books are closed then reopened and in these cases an | | |
| | additional recon will be required. | | |
| | Corporate Actions with Underlying Event | | |
| | S2.2 User changes the status to “Ready for DR”, System should require a “Local Record Date” or | | |
| | “Effective Date” in order to go to “Ready for DR”. | | |
| | S2.3 Another field to the Underlying Event called “Reconciliation Date” should be added. This date | | |
| | will be pre-filled with either the “Local Record Date” or the “Effective Date” | | |
| | S2.4 If both are available, no pre-fill will be done. CA User will be required to manually enter the | | |
| | date if both “Local Date and “Effective Date” are available. | | |
| | S2.5 User Needs the ability to edit the date even though it was pre-filled | | |
| | S2.6 System cannot allow the USER to go to “Ready for DR” unless the “Reconciliation Date” field | | |
| | is filled. Reconciliation date should be tagged to DR Event. | | |
| | S2.7 Security Sale and Mandatory Exchange: (underlying event exists) Once the Pending DR Event is | | |
| | created, the Reconciliation Application should reconcile the Ordinary Shares based on the | | |
| | “Reconciliation Date”. | | |
| | DR Events | | |
| | S2.8 Termination: (No underlying event exists) Once the pending DR Event is created, the | | |
| | Reconciliation Application should reconcile the Ordinary Shares based on the “Reconciliation Date” | | |
| | on the DR Event. The “Reconciliation Date” can be at most one business day before “Initial Sale | | |
| | Date” in MasterFile, but not earlier | | |
| | There may be accrued div. that need to be entered | | |
| | E-mail Alert to close out pending cancellation and draw down inventory should be sent to settlements | | |
| | group 3 weeks before initial sale date. The notification should be resent in week 2 and 1. | | |
| S3.0 | Underlying Event | | |
| | Below is a list of underlying events that have resulted in a Security Sale. A security sale is not | | |
| | limited to the list below and the system should have the ability to process a security sale on any type | | |
| | of underlying Corporate Action. | | |
| | Bonus Issue/Capitalization Issue | | |
| | Conversion | | |
| | Exchange | | |
| | Intermediate Securities Distribution | | |
| | Merger | | |
| | Priority Issue | | |
| | Rights Issue/Subscription Rights/Rights Offer | | |
| | Spin-Off | | |
| | Tender/Acquisition/Takeover/Purchase Offer/Buyback | | |
| | DR Event | | |
| | When user selects type of DR event it will result in a security sale/cash distribution | | |
| | Termination: Sell Underlying Shares | | |
| | Security Sale: Sell Entitlement Security | | |
| | Note: Entitlement may be sold through a “book build” - if cash is received process local FX and | | |
| | distribute USD | | |
| | Mandatory Exchange: Cash or Shares on Underlying Shares | | |
| | a) If Cash: Do local FX and distribute USD (Cash Distribution) | | |
| | b) If Shares: Sell entitlement | | |
| S4.0 | Custodian Confirmation of Credit MT566 | | |
| | The DR event should be modified with a summary screen to show the Confirmation of position from | | |
| | each custodian. These SWIFT should be automatically tagged to the DR event. | | |
| | The system should provide the ability to upload the Custodian Confirmation of Credit. The | | |
| | confirmation can come in form of a SWIFT, e-mail or fax. | | |
| | Users will need the ability to manually enter information on the MT566 since there are multiple | | |
| | methods of receiving the confirmation. Suggested fields are listed at the bottom of this section | | |
| | The System should do a validation of Entitlement received versus the expected amount for each | | |
| | Custodian and Entitlement. If it does not match then a warning message should appear | | |
| | A) The expected amount can be calculated by taking the product of the reconciled Ordinary | | |
| | Position and the entitlement rate. | | |
| | B) The Entitlement received will be on the MT566 received from the Custodian. | | |
| | C) The MT566 should be automatically tagged to the DR Event | | |
| S5.0 | Calculating Shares to Sell | | |
| | This panel will be used to calculate the quantity of Entitlements to sell on a moving basis. | | |
| | S5.1 A link should be provided at this screen to the Reconciliation Application to view the recon for | | |
| | the particular event. | | |
| | S5.2 The adjustments/BDM made in the reconciliation application should pull into this panel and | | |
| | provide the ability for GCAT to include/exclude Entitlements to sell. A comments field should be | | |
| | provided to explain the reasoning for this. Reason codes will be provided in the future | | |
| | S5.3 Information should be broken down by Custodian. Issuer can have multiple custodians and | | |
| | positions held there and adjustments will be made at that level. | | |
| | NOTE: When calculating distribution, the system needs to take into account whether the DRs were | | |
| | Issued or Cancelled. This affects rate calculation and funds distribution | | |
| | S5.6 IF THERE IS AN ENTITLEMENT: Entitlement Rate needs to be displayed | | |
| | A) System should pull the rate from the underlying event, but allow the USER to change the | | |
| | values. The rate is provided on the SWIFT Message | | |
| | B) “x” new entitlement for every “y” old Ord(s) held | | |
| | C) When calculating the entitlement rate it is important to use the position that has been | | |
| | reconciled with any adjustments that were further made by the GCAT team. | | |
| | S5.7 QIB Carve In/Out | | |
| | A) Build a QIB Certification Panel | | |
| | B) USER inputs certification and saves. | | |
| | C) Require Upload of QIB Cert Form | | |
| | S5.8 System needs to calculate the final gross amount of distribution currency received. The system | | |
| | should be flexible in calculating that distribution rate in any currency besides USD | | |
| | System should calculate the number of DRs to distribute funds | | |
| | Note: that pending issuance/cancellation may result in a rate distribution on shares that may not have | | |
| | been issued or cancelled. | | |
| S6.0 | Sell Request | | |
| | The profile should be designed to input sale request information per entitlement and list the quantity | | |
| | being sold by Custodian. If Ords are held in London, then the FX will be done by London office, but | | |
| | NY will still process a Nostro ticket. | | |
| | S6.1 For one entitlement, system should have ability to create two sale requests through different | | |
| | methods | | |
| | S6.2 For one entitlement, create multiple request to sell different quantities (entire position may not | | |
| | be sold in one request) | | |
| | Suggested fields at bottom of section | | |
| | S6.3 Tracking Quantity of Entitlements to sell | | |
| | The system needs the ability to track the quantity of entitlements available to sell | | |
| | Field | Data | |
| | Available to Sell | Reconciled Position(after GCAT | |
| | | Adjustments) - Unapproved, Pending, | |
| | | approved and completed sales requests | |
| | Pending Sell | Entitlements that have been approved to sell | |
| | Requests | | |
| | Completed Sales | Quantity of entitlements that Sale | |
| | | Confirmations have been received on | |
| | S6.4 Cancel Sale Request | | |
| | User needs the ability to cancel a sell request. There will be situations where a request to sell has | | |
| | only been partially filled. The system needs the ability to recognize this and only add the quantity | | |
| | that had not been sold back to the available quantity to sell inventory. Once this sale request is | | |
| | canceled the “Residual” quantity remaining to sell should be added back to the available quantity to | | |
| | sell inventory. | | |
| | There will be situations where a request to sell has only been partially filled. The system needs the | | |
| | ability to recognize this and only add the quantity that had not been sold back to the available quantity | | |
| | to sell inventory. | | |
| | S6.5 Approval Process | | |
| | Once the security sale request is completed, the user should have the ability to send the profile for | | |
| | approval to an authorized signer. A notification should be sent to the authorized signers. notifying | | |
| | them that action is needed. | | |
| S7.0 | S7.1 ConvergEx Sell Request Ticket | | |
| | Once the sell request profile has been approved and it was requested to “Sell Through” ConvergEx, | | |
| | then an e-mail should be sent with the ConvergEx Sale ticket through e-mail. ConvergEx provides | | |
| | prime services to professional investors including Hedge Funds, Family Offices, Mutual Funds, and | | |
| | Registered Investment Advisors. | | |
| | An example sell ticket will be provided and the fields within the form should be automatically | | |
| | populated. | | |
| | The system should check if the Custodian is BNYMellon London. If so, then the system should send | | |
| | the Sell Ticket to ConvergEx and CC the BNYMellon London Custodian | | |
| | Suggested fields for the ticket are at bottom of section an example sale ticket will be provided. | | |
| | S7.2 Custodian Sale Request | | |
| | Once the Sale Request Profile is approved and selling through Custodian is selected the system | | |
| | should automatically create an MT 543 (Delivery vs. Payment) and MT 542 (Delivery Free) to send | | |
| | the settlement Instructions. This may be done when selling through ConvergEx and the shares are | | |
| | NOT held at BNYMellon London. If this is not completed in phase 1 then users need the ability to | | |
| | upload the SWIFT to the DR event for back up documentation. | | |
| | System should have ability to generate a SWIFT message with generic verbiage that will be provided | | |
| | at later date. | | |
| S8.0 | S8.0 Sale Confirmation Profile | | |
| | The System will need the ability on the DR event to input information provided on the sale | | |
| | confirmation ticket from ConvergEx, Custodians and others. The confirmation is not standard and can | | |
| | be sent via e-mail, spreadsheet attachment, SWIFT or fax. The System should have ability to auto | | |
| | populate SWIFT Messages. | | |
| | The fields below should be available for the user to manually input the following information | | |
| | The System should allow the flexibility to upload the spreadsheet (ConvergEx Confirmation) into the | | |
| | system and have the fields below automatically populate on the CA System. | | |
| | Sale Confirmation | | |
| | Field | Data | Notes |
| | Trade Date | DD/MM/Year | |
| | Settle Date | DD/MM/Year | |
| | ISIN | | |
| | ISIN Name | Instrument Name | |
| | Executed Price | Can be up to 6 decimal | |
| | | places long | |
| | Currency | Currency Type | |
| | Quantity Filled | Amount Bought/Sold | |
| | Custodian Name | Name of Custodian | Drop Down Menu |
| | | where the Quantity sold | |
| | | are held | |
| | Principal Cash | Units sold up to 6 | |
| | Amount | decimal places | |
| | Commission | Amount of commission | |
| | | up to 6 decimal places | |
| | Other Fees | Other fees up to 6 | Drop down with |
| | | decimal places | options: |
| | | | 1) Tax |
| | | | 2) Exchange |
| | | | 3) other |
| | Projected Net | Net amount from sale | This is funds that |
| | Amount | (minus commission, | are “projected” to |
| | | Other Fees and taxes) | receive |
| | Actual Net | Amount receive by | S9.00 |
| | Amount | Custodian | |

| System should check that quantity filled does not exceed the quantity order. An error message should | |
|---|---|
| appear. | |
| Alert should be given if actual and projected do not match | |
| Clearing Agent | |
| Global Corporate Action Team (GCAT) users will need a front end to manually input the settlement | |
| instructions for a particular DR Event. | |
| Below are the following fields | |
| Field | Data |
| Clearing Agent Name | |
| Account Number | |
| Safekeeping/SEC | |
| Account | |
| Broker Name | |
| Broker BIC | |
| Comments | |

| S8.1 ConvergEx Sell Ticket Confirmation Upload | | |
|---|---|---|
| The system needs the ability to upload the following sale confirmation from ConvergEx and auto | | |
| populate the sale confirmation screen. An example will be provided. | | |
| Suggested fields at bottom of section. | | |
| S8.2 ConvergEx Sell Ticket Confirmation Check | | |
| The system should perform the following checks on the Sell Ticket Confirmation. When the user | | |
| inputs the trades and continues to save the confirmation, the system should perform the checks below. | | |
| If the user enters information that does not add up when performing check then the system should | | |
| provide a warning before continuing to save. | | |
| User should have ability to continue even though there is a difference. | | |
| Field | System Check | |
| Principal | Qty Executed (x) Price | |
| Commission | Principle (x) Commission | Commission table to be |
| | Basis Points | provided |
| Net Amount | Gross (—) Commission (—) | |
| | Tax | |

| S.9.0 | Credit of Funds | |
|---|---|---|
| | Users will need the ability to upload confirmation to DR event for backup documentation. Custodians | |
| | will fax/e-mail/send SWIFT confirming the receipt of cash into the nostro account. | |
| | This revenue should be recognized as “actual funds received” (in foreign currency) in S8.0 Sale | |
| | confirmation. The DR user may not receive any of the notification and will need to manually check | |
| | the nostro reports. | |
| | This cash amount should be further used to convert funds if need into USD and should feed to the | |
| | cash payment panel. | |
| S10.0 | Foreign Exchange Panel | |
| | S10.0 A link should be provided at this screen to bring users to the foreign exchange (FX) module. | |
| | S10.1 When “Method used to Convert Funds” is the “DR Business” then an FX contract will be | |
| | completed. | |
| | S10.2 When the method is ConvergEx, Custodian, London or other then users need the ability to store | |
| | the FX rate used on the DR event. When “ConvergEx” or “Custodian” is selected a GL ticket should | |
| | automatically be generated to accept funds wire. When “London” is selected GL tickets should still | |
| | be generated with London's Nostro information. | |
| | Field Name | Values |
| | Foreign Payable Date | Open Field |
| | Country | Auto Populate |
| | Currency | Auto Populate |
| | | Currency Abbreviation |
| | Expected Foreign | Auto Populate |
| | Currency Amount | |
| | Trade Date | Open field |
| | U.S. Value Date | Open Field |
| | Conversion Rate | Open field for numbers up |
| | | to 6 decimal places |
| | Total | Actual Foreign Currency |
| | | Amount (x) Conversion |
| | | Rate = Total |
| | Trader's Name | Open Field |
| | Foreign Funds are located | Open Field |
| | at: | |

| | S10.3 FX Approval Process | |
|---|---|---|
| | Once the FX Profile is completed, the user should have the ability to send the profile for approval to | |
| | an authorized signer. A notification should be sent to the authorized signers notifying them that action | |
| | is needed. | |
| S11.0 | Security Sale Report | |
| | The system should have the ability to provide a report in excel similar to the current log and filtered | |
| | by the following. Report should have the ability to “hyperlink” to Sell Confirmation/FX Contract. | |
| | 1) All 2) Country 3)Region 4) Issuer 5) S/U 6) Approved Event 7) Pending Event Information at | |
| | top or report | |
| | Issuer Name | MasterFile |
| | CUSIP | Corporate Action |
| | Ords a/o RD | |
| | Ordinary ISIN | |
| | Entitlement ISIN | Corporate Action |
| | Entitlement Rate | 1:1 |
| | Canceled Sale Requests | Total amount of Canceled sale requests |
| | Available | |
| | “Other Fees” from S8.0 should appear on report | |
| | Column | Data |
| | Activity | |
| | Type | |
| | Sale Date | |
| | Sale Amount | Quantity sold Sale confirmation |
| | Quantity Filled | Sale Confirmation |
| | Residual | Total amount requested (—) Sale Amount |
| | Trade Date | Sale Confirmation |
| | Settlement Date | Sale Confirmation |
| | Currency | FX Profile |
| | Price Executed | Sale Confirmation Profile |
| | Principle Cash Recieved | Quantity Filled (X) Price Executed |
| | Commission Fees | Sale Confirmation |
| | Exchange Fees | Corporate Action |
| | Net Funds | Gross sales(—) Commission (—) Exchange |
| | | fees |
| | FX Value Date | FX Profile |
| | FX Rate | FX Profile |
| | Revenue USD | General Ledger |

| S12.0 | Distribution Rate | |
|---|---|---|
| | The system needs to calculate the final gross rate and create the following announcements | |
| | 1) External Memo | |
| | 2) GCM Memo | |
| | Example announcements will be provided and should be automatically posted to the website | |
| | Unsponsored Pre-Release Notification GCM | |
| | Notification should be sent to GCAT notifying them to call back pre-release | |
| S13.0 | Distribution Rate Approval Process | |
| | Once the Distribution rate is completed, the user should have the ability to send for approval. | |
| | A notification should be sent to authorize signers notifying them that action is needed. | |
| S15.0 | Audit Trail | |
| | The system should provide the ability to view an audit trail of any data that is inputted by a user. The | |
| | system should also track any approval process (who generated the report and approved it). | |
| S16.0 | Security Sale Worksheet (Internal Report) | |
| | The system should provide the ability to create the following report | |
| | Field | Data |
| | Date | Todays Date |
| | Issuer Name | |
| | S/U | |
| | Ticker | |
| | Country | |
| | Region | |
| | Transaction Type | Corporate Actions Type |
| | CUSIP | MasterFile |
| | Ratio | MasterFile |
| | Terms of Offer | SWIFT 564/568 |
| | Administrator | MasterFile |
| | Exchange | MasterFile |
| | Foreign Record Date | SWIFT |
| | DR Record Date | Distribution Rate Profile |
| | DR Payable Date | Distribution Rate Profile |
| | Custodian Mnemonic | Custodian Profile |
| | | MasterFile |
| | ORDs Shs | Ordinary Shares |
| | Entitlement Rec'd | ADRs shs |
| | <<Currency | Sale Confirmation |
| | Abbreviation>> Rec'd | |
| | FX Rate | FX Profile |
| | USD Rec'd | FX Profile |
| | US Distribution Rate | U.S Dollars |
| | | Received/Total DRs = US |
| | | Distribution Rate |
| | Gross Rate Per ADS | Calculation from US |
| | | Distribution Rate |
| | Depositary Service Fee | Auto Populate Negotiated |
| | | Amount |
| | Net Rate Per ADS | Gross Rate − Depositary |
| | | Service Fee = Net Rate per |
| | | ADS |
| | Total Amount Rec'd | Auto Populate GLs |
| | Funds Paid to Holders | Net Rate per ADS (x) |
| | | Total DRs Outstanding |

| | |
|---|---|
| S17.0 | Booking Fees and Debiting Down Positions (Ordinary Shares) |
| | Ordinaries (Terminations) |
| | System should automatically book fees in Corporate Action System on the effective date |
| | A notification should be sent to DROps attaching the security sales worksheet. |
| | Users need the ability to store a BDM after the profile has been approved. This BDM is issued after |
| | the approval of the security sales. |
| | An e-mail should be sent to SOS. Example notice will be provided and includes the BDM number. |
| S18.0 | Auto Populate Cash Distribution Panel |
| | For entitlement security sales there will be a related event for the cash distribution. |
| | Once the distribution rate is Approved the information should auto populate the cash distribution |
| | panel and a cash distribution announcement should be created. See cash distribution workflow |
| | The cash distribution panel should have the ability to enter information in US dollars |
| | The last trade Date should be equal to the Foreign pay date on the cash distribution panel. |
| | If there is DTC inventory, it should be populated on the cash distribution screen and treated as |
| | treasury |
| S19.00 | Due Bills |
| | Once the Cash Distribution Rate has been approved in Corporate Actions the system should perform |
| | the following calculation to determine if there is a difference of 15% or more. |
| | Stock Price(MasterFile)/Gross Rate per ADS |
| | If it is 15% or more then the system should send a notification to GCAT, Dividends and Recon the |
| | following business day alerting them to check for due bills at DTC |
| | If Due Bills |
| | System should provide the ability for the user to indicate (yes) that there are due bills and input the |
| | Due Bill Period Dates (dates that the books will re-open). The dates can be used in future phases |
| | when the books closed gets automated. |
| | The system should also provide flexibility to input the information regardless of the DR event being |
| | in an approved status or not. |
| S20.00 | Fed Wire |
| | The system should generate fed wire tickets. |
| | Once the fed wire is created, the system should automatically generate a GL ticket |

1. A data processing system including a processor for analyzing, processing, and outputting information associated with an underlying corporate action (CA), the system comprising:
a communications module configured to operably couple to an external communications network;
a message processing module operable to receive, via the communications module, data from an issuer providing notice of the underlying corporate action;
an assignment module configured to parse the data from the issuer and to associate one or more of the issuer, a corporate action event type, and a responsible group to the underlying corporate action and to store associated data elements parsed from the data from the issuer in a memory;
an external data feed module communicably coupled to the communications module and configured to query and receive third party information related to the notice of the underlying corporate action, said external data feed module operable to identify discrepancies between the data elements parsed from the data from the issuer in the memory and the third party information, and to request confirmation and/or correction of the received third party information responsive to an identification of one or more discrepancies between the data elements in the memory and the third party information;
an administrative module coupled to the external data feed module and through which, responsive to resolution of all discrepancies between the data elements in the memory and the third party information, a relationship manager approves the underlying corporate action as a golden event, any corrected data elements being stored in the memory;
an announcement processing module which, responsive to approval of the golden event, prepares and publishes an automated announcement concerning the underlying corporate action to one or more of the issuer, a securities exchange, and a securities clearinghouse over the external communications network,
wherein, responsive to the publication of the announcement, the external data feed module again queries and receives third party information related to the announcement and reverifies consistency of the third party information with the announcement; the external data feed module requesting confirmation and/or correction of the received third party information related to the announcement responsive to an identification of one or more discrepancies between information associated with the underlying corporate action stored in the memory and the third party information.

2. The data processing system of claim 1, further comprising a distribution module that analyzes financial details of a proposed distribution in the underlying corporate action and enters related distribution data into the memory, and which reconciles a client security position in response thereto.

3. The data processing system of claim 2, further comprising a foreign currency exchange module which, responsive to receipt of a corporate action related to a depositary receipt for a foreign security denominated in a first currency, approximates a corresponding payment in a second currency, extends a payable date, and generates a revised corporate action notice that modifies the underlying corporate action.

4. The data processing system of claim 1, further comprising a depositary service fee (DSF) processing module that generates a DSF notice for one or more securities depositories, identifies a record date for registered shareholders in connection with the underlying corporate action, and generates a DSF collection notice for the registered shareholders.

5. The data processing system of claim 4, wherein the DSF processing module links to an associated DSF accrual stored in the memory and reconciles a client security position.

6. The data processing system of claim 4, further comprising a financial report module configured to provide a DSF forecast report and a record date position report in connection with a DSF accrual for a particular depositary receipt.

7. The data processing system of claim 1, wherein the underlying corporate action is associated with a depositary receipt.

8. The data processing system of claim 1, wherein the external data feed module is configured to reconcile all corporate action notices using multiple data sources before publication thereof.

9. A computer-implemented method for analyzing, processing, and outputting information associated with an underlying corporate action (CA), the method comprising:
providing a data processing system comprising a memory coupled to a processor and containing a database therein configured to at least store information related to the underlying corporate action and client-related information, said data processing system being communicatively couple to a communications network;
analyzing, by the processor, a CA notice received from an issuer;
requesting, by the processor, alternative notification information for the CA notice from a third party data vendor;
confirming, by the processor, consistency between CA information in the CA notice and the alternative notification information;
responsive to any data inconsistency, requesting correction of either the CA information, the alternative notification information, or both;
responsive to data consistency, declaring a golden event and publishing a CA announcement;
reviewing alternative data sources provided in response to the CA announcement and determining whether any new data inconsistency exists; and
prior to any further processing, ensuring that said any new data inconsistency has been resolved, wherein said any new data inconsistency is identified by the processor.

10. The method of claim 9, further comprising:
via the processor, identifying details associated with a distribution in the corporate action;
publishing the CA announcement comprising the details associated with the distribution over the communications network; and
notifying a transfer agent via the communications network of the distribution.

11. The method of claim 10, wherein the underlying corporate action is related to a foreign security having an associated depositary receipt, and wherein the distribution is denominated in a first currency, the method further comprising:
providing foreign exchange processing of the distribution;
extending a payable date of the CA announcement; and
approximating a payment of the distribution in a second currency.

12. The method of claim 10, wherein the distribution is a cash dividend.

13. The method of claim 10, wherein the distribution is a cash distribution resulting from selling or exercising a distribution right associated with a foreign stock.

14. The method of claim 9, further comprising:
determining, via the processor, whether a depositary service fee is authorized;
generating a DSF notice for one or more securities depositories;
identifying a record date for registered shareholders in connection with the underlying corporate action, and
generating a DSF collection notice for the registered shareholders.

15. The method of claim 9, further comprising:
linking to an associated DSF accrual stored in the memory; and
reconciling a client security position.

16. The method of claim 9, further comprising:
providing a DSF forecast report and a record date position report in connection with a DSF accrual for a particular depositary receipt;
responsive to the DSF forecast report and the record date position report, calculating a DSF accrual;
generating a general ledger ticket; and
updating DSF data stored in the memory responsive to the general ledger ticket.

17. An article of manufacture comprising a non-transitory computer-readable storage medium that contains computer-executable code therein which, when executed by a processor, causes the processor to carry out functions that analyze, process, and output information associated with an underlying corporate action (CA), wherein the executable code is operable to:
analyze, by the processor, a CA notice received from an issuer;
request, by the processor, alternative notification information for the CA notice from a third party data vendor;
confirm, by the processor, consistency between CA information in the CA notice and the alternative notification information;
responsive to any data inconsistency, request correction of either the CA information, the alternative notification information, or both;
responsive to data consistency, declare a golden event and publish a CA announcement;
review alternative data sources provided in response to the CA announcement and determine whether any new data inconsistency exists; and
prior to any further processing, ensure that said any new data inconsistency has been resolved, wherein said any new data inconsistency is identified by the processor.

18. The article of manufacture of claim 17, wherein the executable code is further operable to:
identify details associated with a distribution in the corporate action;
publish the CA announcement comprising the details associated with the distribution over the communications network; and
notify a transfer agent via the communications network of the distribution.

19. The article of manufacture of claim 18, wherein the underlying corporate action is related to a foreign security having an associated depositary receipt, and wherein the distribution is denominated in a first currency, wherein the executable code is further operable to:
provide foreign exchange processing of the distribution;
extend a payable date of the CA announcement; and
approximate a payment of the distribution in a second currency.

20. The article of manufacture of claim 18, wherein the distribution is a cash dividend.

21. The article of manufacture of claim 18, wherein the distribution is a cash distribution resulting from selling or exercising a distribution right associated with a foreign stock.

22. The article of manufacture of claim 17, wherein the executable code is further operable to:
determine, via the processor, whether a depositary service fee is authorized;
generate a DSF notice for one or more securities depositories;
identify a record date for registered shareholders in connection with the underlying corporate action, and
generate a DSF collection notice for the registered shareholders.
